(19) United States
(12) Patent Application Publication
(10) Pub. No.: US 2026/0241262 A1
(43) Pub. Date: Aug. 20, 2026

(54) SYSTEM AND METHOD FOR PROJECTILE DETECTION, VELOCITY TRACKING, AND MAGNUS EFFECT ANALYSIS

(71) Applicant: ScoutEdge Co, Austin, TX (US)

(72) Inventor: Calvin Bush, Austin, TX (US)

(21) Appl. No.: 19/541,727

(22) Filed: Feb. 17, 2026

Related U.S. Application Data
(60) Provisional application No. 63/759,865, filed on Feb. 18, 2025.

(51) Int. Cl. A63B 71/06; A63B 102/18; G06T 7/277

(52) U.S. Cl. CPC A63B 71/0619; G06T 7/277; A63B 2102/18; A63B 2220/05; A63B 2220/13; A63B 2220/31; A63B 2220/35; A63B 2220/62; A63B 2220/806; A63B 2225/02; G06T 2207/10016; G06T 2207/20081; G06T 2207/20084; G06T 2207/30224; G06T 2207/30241

(57) ABSTRACT

A method, system, and computer-readable medium for analyzing projectile motion. Image data comprising at least two frames capturing a projectile is received. A spatial relationship between a capture device and an environment is determined, such as through extrinsic calibration using detected keypoints. A first machine learning model detects the projectile within the frames to generate projectile coordinates. The projectile coordinates are processed to generate a projectile trajectory, including applying filtering to reduce noise. A second machine learning model, such as a transformer-based neural network, estimates flight characteristics of the projectile based on the trajectory and parameters derived from the spatial relationship. The flight characteristics, which may include initial position, initial velocity, spin axis, spin efficiency, and spin rate, are refined using a physics-driven optimization algorithm. One or more projectile metrics, such as velocity, vertical break, horizontal break, and release location, are calculated from the refined flight characteristics.

### CROSS-REFERENCE TO RELATED APPLICATIONS

The application claims priority to U.S. Provisional Application No. 63/759,865, filed Feb. 18, 2025, entitled “SYSTEM AND METHOD FOR PROJECTILE DETECTION, VELOCITY TRACKING, AND MAGNUS EFFECT ANALYSIS”, the entire contents of which are incorporated herein by reference.

### FIELD

The present disclosure generally relates to the technical field of identifying moving objects in video feeds and files, and calculating analytics data based upon those moving objects; and in particular, identifying thrown baseballs by baseball pitchers and calculating baseball pitcher performance data over a distributed computing network.

### BACKGROUND

The sport of baseball has increasingly relied on statistical analysis at the professional, collegiate, and high school level in determining the abilities of prospective players. Due in part to the subjectivity and difficulty in analyzing players on site or in person, baseball scouts are increasingly relying on technical solutions, such as recorded performance video and statistical analysis of those performance videos. In using video analytics, a baseball scout can be provided with data points such as a pitcher average pitch speed as a single numerical data point, rather than as a collection of videos of the pitcher pitching, or unverifiable attestations of numerical performance.

However, contemporary solutions for analyzing, for example, baseball pitchers pitching performance require cumbersome and expensive proprietary on-site hardware which utilize multifaceted remote sensing technologies, like combined LiDAR, RADAR, and video systems. Many otherwise promising baseball prospects do not have access to facilities with such on-site, and consequently baseball team scouts overlook these potential players. Additionally, many of these on-site solutions are on-site because the amount of data collected and the analytics performed on the data can be complex and unwieldy to transfer and process over conventional data networks.

Although conventional video equipment such as smartphones and similar device can be used to collect data, any collected data sets are smaller in size than necessary to perform the required processing to produce useful and reliable analytics. Thus, these limited data sets have reduced value in any sort of analytical or machine learning applications, which would otherwise produce valuable insights and forecasts.

Conventional video analysis systems that attempt to analyze projectile motion using consumer-grade cameras face numerous technical challenges that have prevented the development of accurate and practical solutions. First, consumer-grade cameras lack the specialized synchronization and timing hardware present in professional motion capture systems, resulting in imprecise frame timing that introduces errors in velocity calculations. Second, the relatively low frame rates available on consumer devices (typically 240 frames per second or lower) mean that fast-moving projectiles such as pitched baseballs may only appear in a small number of frames during their flight, providing limited data from which to estimate trajectory and spin characteristics. Third, the lack of depth information in conventional two-dimensional video makes it fundamentally challenging to recover the three-dimensional trajectory of the projectile from the two-dimensional image projections. Fourth, the computational resources available on consumer devices are limited compared to dedicated analysis workstations, requiring optimization techniques to enable real-time or near-real-time processing. Fifth, the natural motion blur that occurs when capturing fast-moving objects at typical consumer camera exposure times can obscure the projectile and reduce tracking accuracy. Sixth, varying lighting conditions, weather conditions, and camera positions in real-world usage scenarios create variability that is difficult to address with conventional computer vision techniques. The present invention addresses these technical challenges through a combination of novel machine learning architectures trained on physics-informed synthetic data, physics-based optimization that leverages known aerodynamic principles to constrain and refine estimates, and a distributed processing architecture that allocates computational tasks between client and server devices in a manner that balances accuracy, latency, and resource consumption.

Thus, there remains a persistent need to perform athletic analytics using conventional or consumer video hardware (such as a smartphone), for assuring authenticity of those analytics values provided by that conventional video hardware, and for machine learning systems which produce insights and forecasts of athletic performance.

### BRIEF DESCRIPTION OF THE DRAWINGS

A method is provided for analyzing projectile motion. The method comprises receiving image data comprising at least two frames, the at least two frames capturing a projectile. The method further comprises determining a spatial relationship between a capture device and an environment. The method further comprises detecting, using a first machine learning model, the projectile within the at least two frames to generate projectile coordinates. The method further comprises processing the projectile coordinates to generate a projectile trajectory. The method further comprises estimating, using a second machine learning model, flight characteristics of the projectile based on the projectile trajectory and parameters derived from the spatial relationship. The method further comprises refining the estimated flight characteristics. The method further comprises calculating one or more projectile metrics from the refined flight characteristics.

In some embodiments, receiving the image data comprises capturing, by a camera, video comprising the at least two frames.

In some embodiments, the video is captured at a frame rate of at least 240 frames per second.

In some embodiments, determining the spatial relationship comprises performing an extrinsic calibration to determine a position of the capture device in three-dimensional real-world coordinates relative to the environment.

In some embodiments, performing the extrinsic calibration comprises detecting one or more keypoints in the environment. Performing the extrinsic calibration further comprises performing a perspective-n-point calibration process using the detected keypoints.

In some embodiments, detecting the one or more keypoints comprises using a pose estimation model.

In some embodiments, the method further comprises detecting, using a video action recognition model, an occurrence of a projectile event within the image data, and responsive to detecting the occurrence of the projectile event, storing a plurality of frames corresponding to the projectile event.

In some embodiments, detecting the occurrence of the projectile event comprises creating windows of a predetermined number of frames from the image data. Detecting the occurrence of the projectile event further comprises feeding the windows to the video action recognition model to generate a probability output. Detecting the occurrence of the projectile event further comprises triggering the projectile event when the probability output exceeds a threshold.

In some embodiments, the first machine learning model comprises an object tracking neural network.

In some embodiments, processing the projectile coordinates comprises applying a filter to the projectile coordinates to reduce noise.

In some embodiments, the filter comprises a Kalman filter. Processing the projectile coordinates further comprises one or more of outlier rejection, gap infilling, and linear interpolation.

In some embodiments, the second machine learning model comprises a transformer-based neural network.

In some embodiments, the flight characteristics comprise an initial state vector including one or more of: initial position components; initial velocity components; spin axis information; a spin efficiency factor; and a spin rate.

In some embodiments, refining the estimated flight characteristics comprises applying a physics-driven optimization algorithm.

In some embodiments, the physics-driven optimization algorithm refines the flight characteristics based on one or more of pixel reprojection errors, physical flight kinematics, and time-of-flight constraints.

A system is provided for analyzing projectile motion. The system comprises one or more processors. The system further comprises a memory storing instructions that, when executed by the one or more processors, cause the one or more processors to receive image data comprising at least two frames, the at least two frames capturing a projectile. The instructions further cause the one or more processors to determine a spatial relationship between a capture device and an environment. The instructions further cause the one or more processors to detect, using a first machine learning model, the projectile within the at least two frames to generate projectile coordinates. The instructions further cause the one or more processors to process the projectile coordinates to generate a projectile trajectory. The instructions further cause the one or more processors to estimate, using a second machine learning model, flight characteristics of the projectile based on the projectile trajectory and parameters derived from the spatial relationship. The instructions further cause the one or more processors to refine the estimated flight characteristics. The instructions further cause the one or more processors to calculate one or more projectile metrics from the refined flight characteristics.

In some embodiments, the system comprises a client device and a server device in communication with the client device. The client device is configured to capture the image data and detect the projectile. The server device is configured to estimate and refine the flight characteristics.

In some embodiments, the second machine learning model comprises a transformer encoder architecture trained using synthetic training data generated by simulating projectile trajectories using physics-based processes.

A non-transitory computer-readable medium is provided storing instructions that, when executed by one or more processors, cause the one or more processors to perform operations. The operations comprise receiving image data comprising at least two frames, the at least two frames capturing a projectile. The operations further comprise determining a spatial relationship between a capture device and an environment. The operations further comprise detecting, using a first machine learning model, the projectile within the at least two frames to generate projectile coordinates. The operations further comprise processing the projectile coordinates to generate a projectile trajectory. The operations further comprise estimating, using a second machine learning model, flight characteristics of the projectile based on the projectile trajectory. The operations further comprise refining the estimated flight characteristics to generate refined flight characteristics. The operations further comprise computing a three-dimensional projectile trajectory based on the refined flight characteristics. The operations further comprise calculating one or more projectile metrics from the three-dimensional projectile trajectory.

In some embodiments, the flight characteristics comprise an initial state vector including initial position components, initial velocity components, and spin information. Refining the estimated flight characteristics comprises applying an optimization algorithm based on one or more of pixel reprojection errors, physical flight kinematics, and time-of-flight constraints.

### BRIEF DESCRIPTION OF THE DRAWINGS

Various aspects of the present disclosure will be or become apparent to one with skill in the art by reference to the following detailed description when considered in connection with the accompanying exemplary non-limiting embodiments, in which:

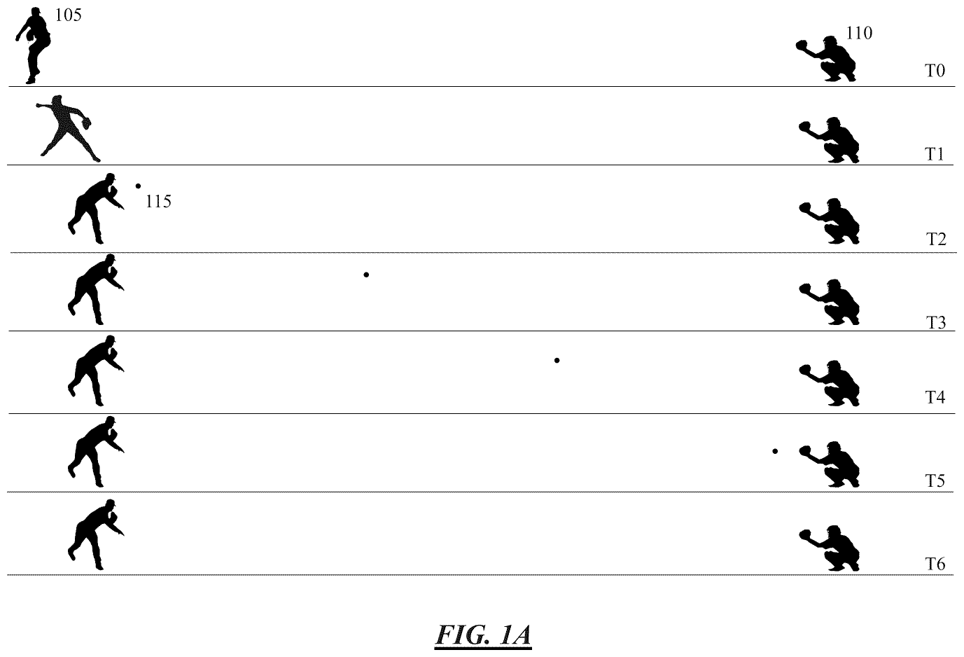

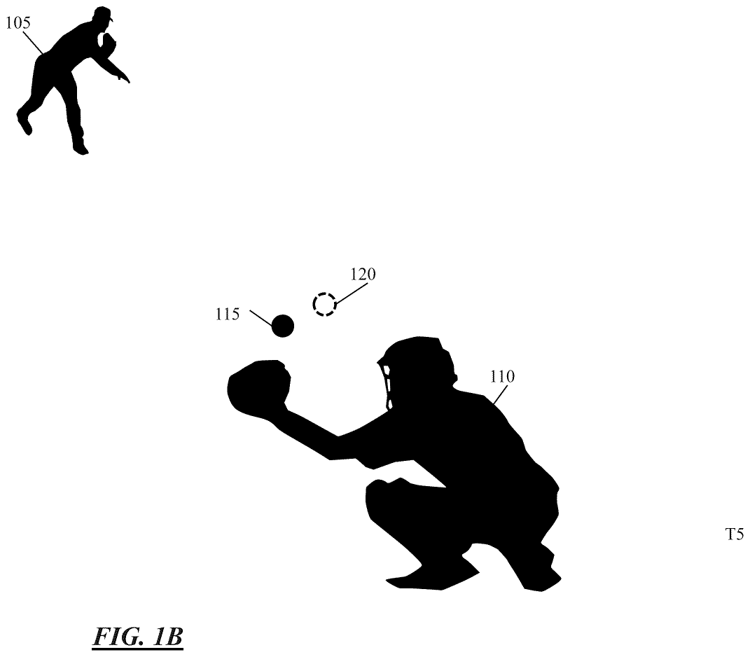

FIG. 1A illustrates several stages of a baseball pitched by a baseball pitcher.

FIG. 1B illustrates the actual penultimate position of a pitched baseball, as compared to a calculated penultimate position of the pitched baseball.

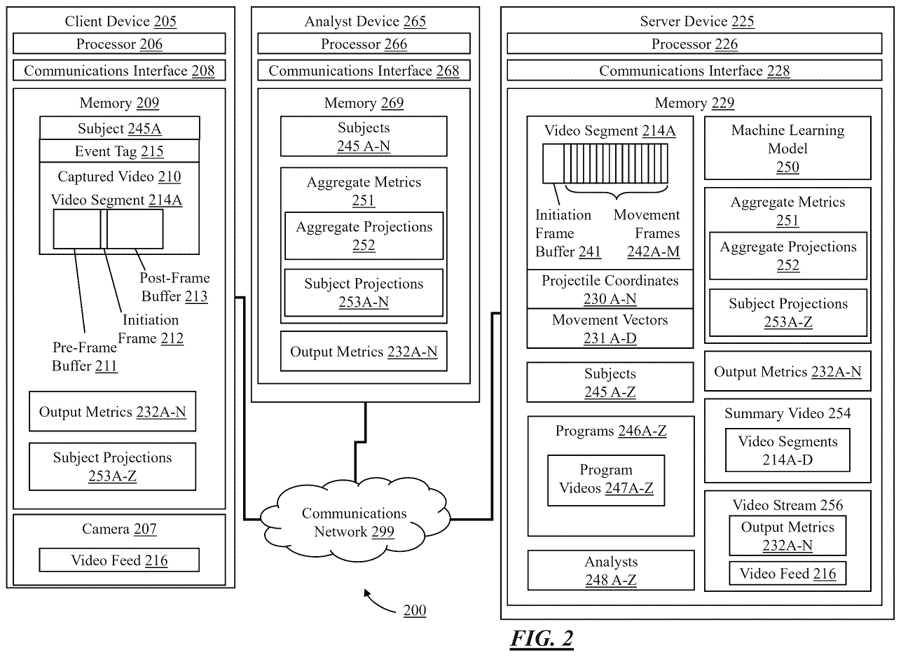

FIG. 2 illustrates components of an exemplary distributed projectile analysis computing environment, in accordance with some exemplary embodiments.

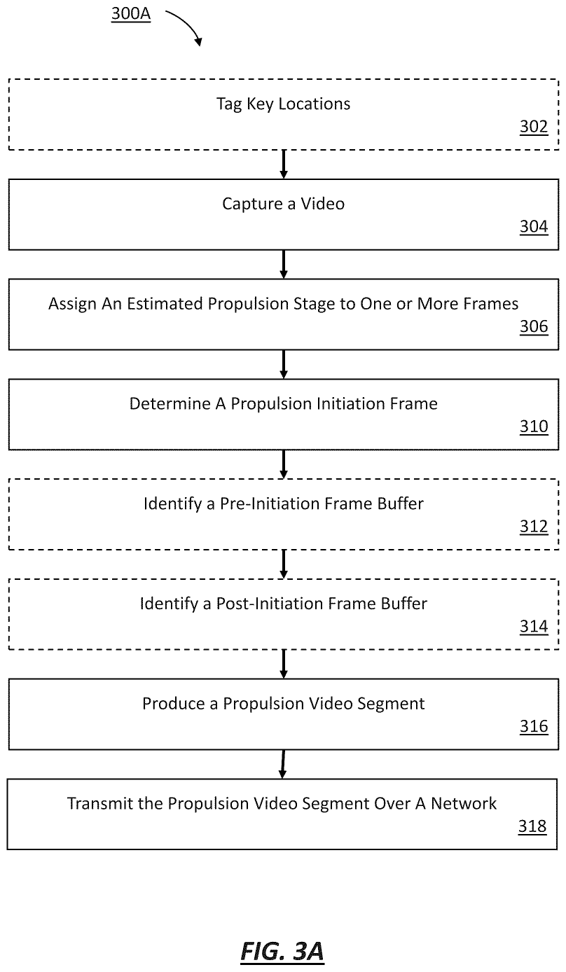

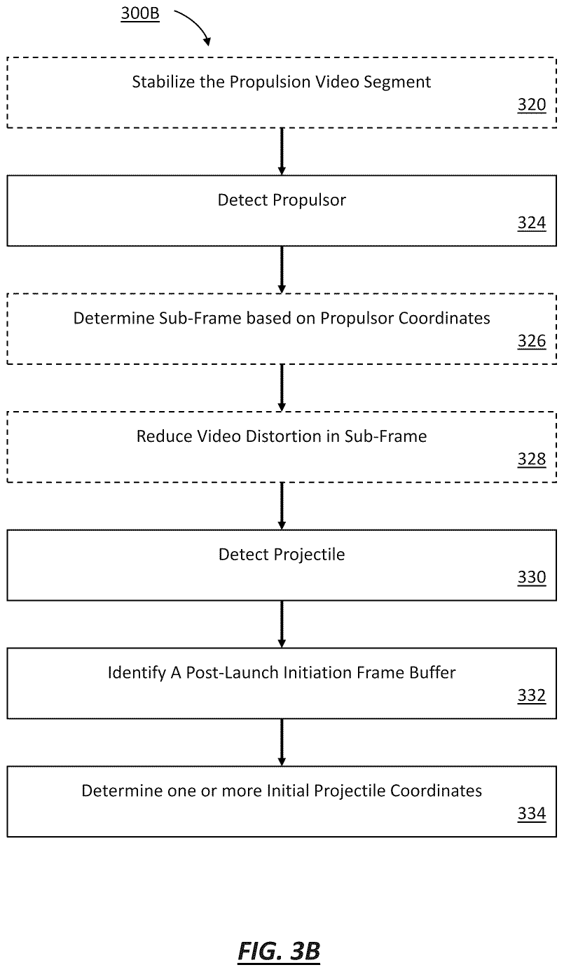

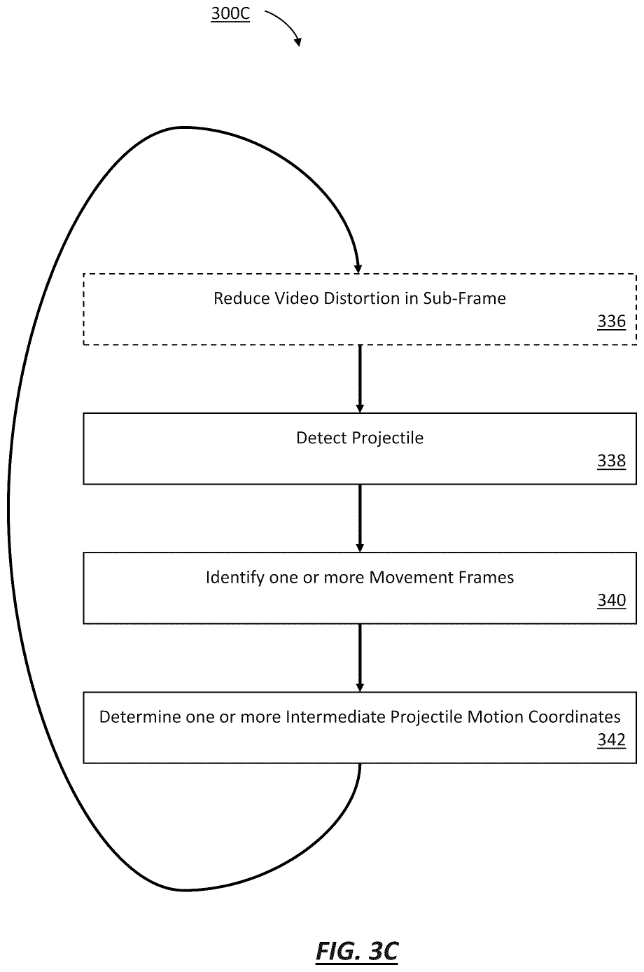

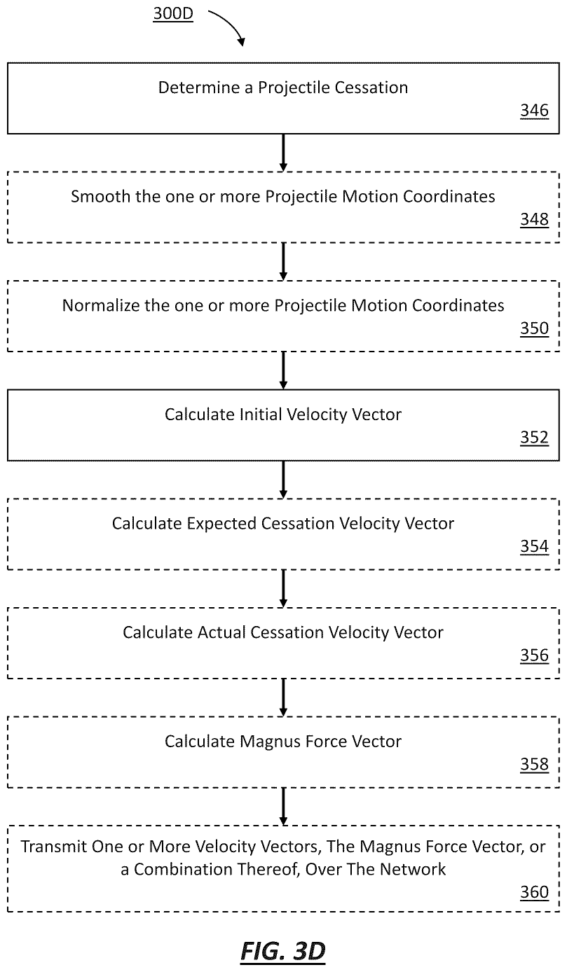

FIGS. 3A-D depict a projectile analysis protocol in accordance with some embodiments of the present disclosure.

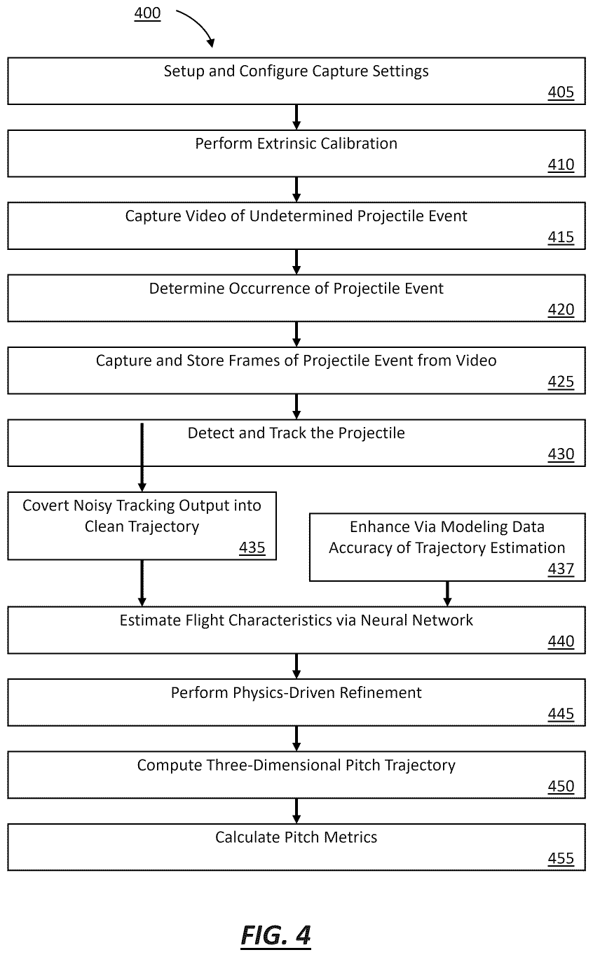

FIG. 4 depicts a pitch capture and analysis protocol in accordance with some embodiments of the present disclosure

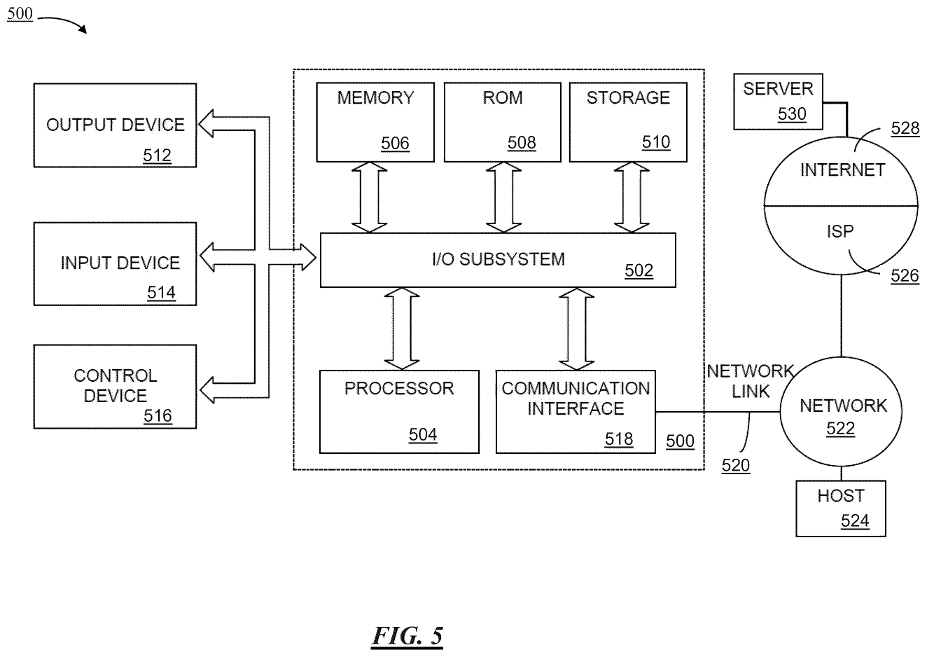

FIG. 5 illustrates a computer system upon which various embodiments may utilize for implementation.

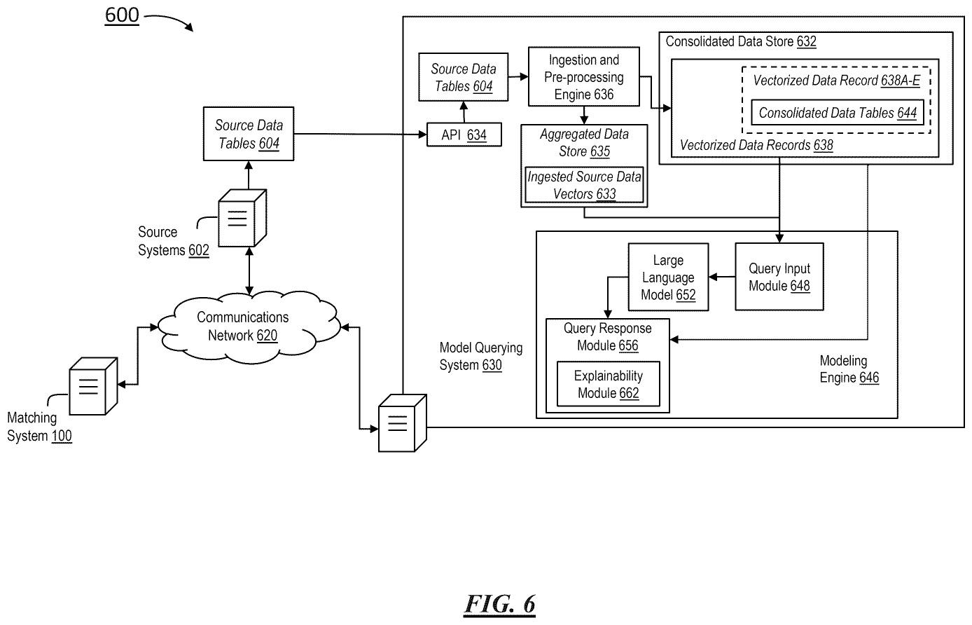

FIG. 6 illustrates components of an exemplary querying computing environment upon which various embodiments may utilize for implementation.

### DETAILED DESCRIPTION OF THE DRAWINGS

This description of the exemplary embodiments is intended to be read in connection with the accompanying drawings, which are to be considered part of the entire written description. The use of the singular includes the plural unless specifically stated otherwise. The use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only, and are not to be construed as limiting the subject matter described. Numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

The following description is provided as an enabling teaching of a representative set of examples. Many changes can be made to the embodiments described herein while still obtaining beneficial results. Some of the desired benefits discussed below can be obtained by selecting some of the features discussed herein without utilizing other features. Accordingly, many modifications and adaptations, as well as subsets of the features described herein are possible and can even be desirable in certain circumstances. Thus, the following description is provided as illustrative and is not limiting.

The term “coupled” as used herein refers to any logical, optical, radio frequency (RF), physical, or electrical connection, link or the like by which signals produced or supplied by one system element are imparted to another coupled element. Unless described otherwise, coupled elements or devices are not necessarily directly connected to one another and may be separated by intermediate components, elements or communication media that may modify, manipulate, or carry the signals.

Reference now is made in detail to the examples illustrated in the accompanying drawings and discussed below.

FIGS. 1A-B depict a baseball pitcher 105 throwing a baseball 115 to a baseball catcher 110, over a span of time extending from T0 to T6. The camera 207 of the client device 205 will produce a captured video 210 of the span of time extending from T0 to T6 (see FIG. 2). At T0, the pitcher 105 has completed their windup. At T1, the pitcher 105 has cocked their arm, and acceleration of the arm of the pitcher 105 is imminent. At T2 the pitcher 105 is in their follow-through, and has released the baseball 115. At T3 and T4 the baseball 115 is proceeding towards the catcher 110. At T5 the catcher 110 is about to catch the baseball 115, and the baseball 115 would be over home plate or between the front and back coronal planes of a batter's box. At T6 the catcher 110 has caught the baseball 115, and the movement of the baseball 115 is arrested and ceased. Returning to T5, in in FIG. 1B the position of the actual baseball 115 is depicted alongside a hypothetical calculated position 120 of the baseball 115. The calculated position 120 is based on the initial velocity vector of the baseball 115 at or near T2, and ignores any movement caused by the rotation of the baseball, such rotation producing a Magnus force, which is a lateral force which acts on a spinning object (such as a baseball 115) moving through a fluid or gas. In baseball, the Magnus force describes the effect of horizontal pitch break and vertical pitch break. The difference between the calculated position 120 and the actual baseball 115 is caused in material part by how the baseball pitcher 105 released the baseball 115—a material difference in calculated position 120 and the actual baseball 115 can be desirable, or alternatively informative, to an analyst ascertaining the pitcher 105.

FIG. 2 depicts an exemplary distributed projectile analysis computing environment 200, in accordance with some exemplary embodiments. The computing environment 200 can include a client device 205, which in some embodiments is a smartphone or another camera-enabled device; an analyst device 265, which in some embodiments is a personal computer; and a server device 225, which in some embodiments is a cloud-based processing and storage server.

In some instances, each of client device 205, server device 225, and analyst device 265 may be interconnected through one or more communications networks, such as communications network 299. Examples of communications network 299 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. Communications network 299 may be a single network, separate networks, overlapping networks, or one may be a virtual communications network running within the other communications network.

In some examples, each of client device 205, server device 225, and analyst device 265 may represent a computing system that includes one or more servers and tangible, non-transitory memories 209, 229, 269 storing executable code and application modules. Further, the one or more servers may each include one or more processors 206, 226, 266, which may be configured to execute portions of the stored code or application modules to perform operations consistent with the disclosed embodiments. For example, the one or more processors 206, 226, 266 may include a central processing unit (CPU) capable of processing a single operation (e.g., a scalar operations) in a single clock cycle. Further, each of client device 205, server device 225, and analyst device 265 may also include a communications interface 208, 228, 268, such as one or more wireless transceivers, coupled to the one or more processors for accommodating wired or wireless internet communication with other computing systems and devices operating within computing environment 200.

Further, in some instances, client device 205, server device 225, and analyst device 265 may each be incorporated into a respective, discrete computing system, such as a smart phone. In additional or alternative instances, one or more of client device 205, server device 225, and analyst device 265 may correspond to a distributed computing system having a plurality of interconnected, computing components distributed across an appropriate computing network, such as communications network 299. For example, server device 225 may correspond to a distributed or cloud-based computing cluster associated with and maintained by the financial institution, although in other examples, client device 205 or analyst device 265 may correspond to a publicly accessible, distributed or cloud-based computing cluster, such as a computing cluster maintained by Microsoft Azure™, Amazon Web Services™, Google Cloud™, or another third-party provider.

In some instances, client device 205, server device 225, and analyst device 265 may include a plurality of interconnected, distributed computing components, such as those described herein (but not necessarily illustrated), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of mitigation system 100 or model-querying system 330 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

In some embodiments, client device 205, in addition to a processor 206, communications interface 208, and memory 209, can include a camera 207. Camera 207 can include any form of optical sensor capable of capturing directly or indirectly any physical phenomena, including as non-exhaustive examples light, heat, electricity, or pressure, as one or more sequential readings or signals. In some embodiments, camera 207 is a conventional digital camera capturing visible light and producing digital images or video feeds 216. In some embodiments, camera 207 is a camera capable of capturing a relatively high number of image frames per second. In some embodiments, camera 207 can capture 240 frames or more per second. In some embodiments, camera 207 can capture up to 156.3 million frames per second.

In some embodiments, the client device 205, server device 225, or a combined integrated device may incorporate one or more supplementary sensors in addition to the camera 207 to enhance projectile detection and tracking accuracy. Such supplementary sensors may include, but are not limited to, inertial measurement units (IMUs) comprising accelerometers and gyroscopes for detecting device motion and orientation during capture; depth sensors such as time-of-flight (ToF) sensors or structured light sensors for direct three-dimensional depth estimation; microphones for detecting acoustic signatures of projectile events such as the impact of a baseball against a bat or the discharge of a firearm; radar or millimeter-wave sensors for direct velocity measurement of the projectile; and light detection and ranging (LiDAR) sensors for generating three-dimensional point cloud representations of the environment and the projectile trajectory. In some embodiments, the system performs sensor fusion by combining data from multiple sensing modalities to improve the accuracy, reliability, and robustness of the projectile detection and tracking. The sensor fusion may be performed using techniques such as extended Kalman filtering, unscented Kalman filtering, particle filtering, or neural network-based fusion methods. In embodiments utilizing multi-sensor fusion, the system may assign weights to data from each sensor based on the confidence level, noise characteristics, or environmental conditions affecting each sensor.

In some embodiments, when a user captures a video of a subject 245A (e.g., of a baseball pitcher 105 throwing a baseball 115) the user produces a captured video 210 from the video feed 216 of the camera. The client device 205 will analyze the captured video 210 using a portion of the projectile analysis protocol 300 (see FIG. 3) to determine an initiation frame 212, which is a frame which the projectile analysis protocol 300 has determined to include the propulsion of the projectile event (e.g., the throwing of a baseball). The protocol 300 also includes a pre-frame buffer 211 or a post-frame buffer 212, or both, depending upon how the initiation frame 212 is determined. For example, when the initiation frame 212 is based on the extension of a baseball pitcher's arm, a post-frame buffer 213 is required to capture the movement of the baseball after the ball is thrown. As an alternative example, if the initiation frame 212 is based on a baseball catcher 210 catching the baseball 211, then a pre-frame buffer 211 is required. In some examples, both buffers 211, 213 are identified. The buffers 211, 213 may not be of the same length, and their respective lengths may be set based upon the recorded activity. In some examples, the buffers 211, 213 are approximately two seconds long each. The initiation frame 212 and one or both buffers 211, 213 in sequence constitute a video segment 214A.

In some embodiments, the video segment 214 is sent to the analyst device 265. By sending only the video segment 214A which is determined to include the projectile event, the entire captured video 210 does not need to be sent over the network 299, saving materially on network bandwidth. In some embodiments, a single captured video 210 can result in multiple video segments 214A-D, such as if the client device 205 records a multi-hour practice session. In such an example, the client device 205 can produce two hundred four second clips: only 13 minutes of captured video 210 will traverse the communications network 299, rather than three hours of captured video.

The transmission of only the video segment 214A rather than the entire captured video 210 represents a significant improvement to the functioning of the computer system and the network. By intelligently identifying and extracting only the portions of the captured video that contain projectile events, the system reduces network bandwidth consumption by a factor that may range from 10 to 100 or more, depending on the ratio of projectile event duration to total capture duration. This reduction in transmitted data volume improves network efficiency, reduces latency in receiving analysis results, reduces server storage requirements, and enables the system to operate effectively even in environments with limited network connectivity. Furthermore, the intelligent segmentation enables the server device 225 to process the received video segments more efficiently because the server need not analyze large volumes of video that do not contain projectile events. The combination of on-device propulsion event detection and network-efficient segment transmission thus represents a technological improvement that enables practical deployment of projectile analysis systems in resource-constrained environments.

The system and method disclosed herein are applicable to projectile analysis in a wide variety of technical fields beyond sports analytics. In the field of ballistics and forensic science, the system may be used to analyze the trajectories of bullets, shell casings, or other projectiles at crime scenes or shooting ranges, enabling reconstruction of shooting events and evaluation of firearm performance. In the field of aerospace engineering, the system may be used to analyze the flight characteristics of drones, unmanned aerial vehicles (UAVs), missiles, or other aerospace vehicles during test flights, enabling evaluation of aerodynamic performance and control system effectiveness. In the field of materials science and manufacturing, the system may be used to analyze the trajectories of particles in spray coating processes, powder metallurgy processes, or additive manufacturing processes, enabling optimization of process parameters. In the field of environmental science, the system may be used to track the movement of birds, bats, insects, or other flying animals, enabling study of migration patterns, flight behavior, and aerodynamic characteristics. In the field of physics education and research, the system may be used to capture and analyze projectile motion demonstrations, enabling quantitative verification of physical principles. In the field of entertainment and gaming, the system may be used to capture real-world throwing or kicking motions for replication in video games or virtual reality environments. In each of these technical fields, the combination of consumer-grade capture hardware, machine learning-based trajectory estimation, and physics-based refinement enables analysis capabilities that were previously available only with expensive specialized equipment.

In some embodiments, server device 225 receives the video segment 214A and continues executing protocol 300. Server device 225 determines an initiation frame buffer 241 e.g., a small buffer of frames immediately after the projectile is propelled (e.g., the baseball is thrown) as well as subsequent movement frames 242A-M, which display the movement of the projectile until cessation (e.g., the movement of the baseball 115 until caught by the catcher 110 or the baseball 115 clears the home plate.) The initiation frame buffer 241 is used to calculate an initial velocity as a movement vector 231A, and that first movement vector 231A is used with the movement frames 242A-M to calculated intermediate movement vectors 231B-C, as well as a Magnus effect vector 231D. Other movement vectors, such as vertical approach angle, release height and extension, pitch zone location are contemplated; as well as exit velocity, launch angle and direction, and contact percentage for baseball batters are contemplated; reaction time, range, and accuracy vectors for baseball fielders are contemplated. Further, movement vectors for other athletes, such as non-exhaustively football, tennis, golf, cricket, lacrosse, field hockey, soccer, volleyball, basketball, rugby, ice hockey, fishing, boxing, martial arts, swimming, shooting sports, and other sport players are contemplated. Movement vectors for (non-exhaustively) firearm projectiles, vehicles, car and aircraft accidents, birds, fish, spacecraft, ergonomics, typing, writing, speech pathology, gait, mechanical repetitive stress testing and observation, laboratory experimentation, security, surveillance, and manufacturing, are all contemplated. Movement vectors 231A-D, along with any other captured or calculated values associated with a particular video segment 214A, constitute output metrics 232A-N.

In some embodiments, server device 225 can include subject 245A-Z data, such as identifiers, which can be associated with data stored in computing environment 200. Server device 225 can also include analysts 248A-Z data, which can also be associated with data stored in computing environment 200. Programs 246A-Z, associated with subjects 245A-Z, analysts 248A-Z, or both, can be stored in server device 225, and associated with program videos produced or owned by respective programs 246A-Z.

In some embodiments, the system implements data integrity and authentication mechanisms to ensure the authenticity and reliability of the captured video data and the calculated output metrics. The client device 205 may generate a cryptographic hash of the captured video segment 214A using a hash function such as SHA-256, and may digitally sign the hash using a private key associated with the client device or the user. The digital signature may be transmitted along with the video segment to the server device 225, which may verify the signature using the corresponding public key before processing the video segment. In some embodiments, the client device 205 may embed a watermark or steganographic signature in the captured video to enable subsequent verification of authenticity. In some embodiments, the system may capture and include metadata with the video segment, such as the timestamp, geolocation, device identifier, and sensor data, to provide additional verification of the circumstances under which the video was captured. The server device 225 or analyst device 265 may perform tamper detection analysis on the received video segment to detect signs of video manipulation or editing. The authenticated video data and output metrics may be stored in a secure data store with access controls and audit logging to maintain a verifiable chain of custody.

In some embodiments, output metrics 232A-N from multiple video segments 214A can be aggregated into aggregate metrics 251. The production of aggregate metrics 251 can be facilitated by a trained machine learning model 250. The aggregate metrics 251 can include aggregate projections, such as an average baseball pitcher velocity. The aggregate metrics 251 can also include subject projections, such as an average pitch velocity for subject 245A. The aggregate metrics 251 can also produce longitudinal data, in particular when multiple video segments 214A-D are produced for the same subject 245A, and further in particular when those multiple video segments 214A-D are produced in the same session. For example, aggregate metrics 251 may be able to determine how many pitches an average baseball player can throw before their average velocity drops below an unacceptable threshold. Or, aggregate metrics 251 may be able to determine how many pitches an average baseball player can throw before unduly risking injury. Or, aggregate metrics 251 may be able to determine how many pitches a particular baseball player 245A can throw before their average velocity drops, or before they are unduly risking injury. Further, these aggregate metrics 251 can be adaptive. For example, while in some examples an aggregate metric like “expected total pitch count” or “expected remaining pitch count” may be static at the start of a session or baseball game (i.e., subject 245A can throw seventy-four pitches in a baseball game before unduly risking injury), in other examples the performance of the subject 245A can be assessed in video segments 214A captured during a session (i.e., baseball game). Thus, aggregate metrics 251 may be able to determine that, for example, when the release point of subject 245A has been below a certain threshold for three of their last five pitches, subject 245A is unduly risking injury and should be removed from play.

In some embodiments, the aggregate metrics 251 may include comparative analysis and benchmarking data that contextualize the performance of individual subjects relative to peer groups. The system may maintain performance distributions for subjects categorized by skill level (such as high school, collegiate, or professional), age, handedness, pitch type, or other relevant attributes. For each calculated output metric, the system may compute a percentile ranking indicating where the subject's performance falls within the relevant distribution. The comparative analysis may identify strengths and weaknesses relative to peers and may highlight areas where the subject's performance deviates significantly from typical patterns. In some embodiments, the system may generate personalized development plans based on the comparative analysis, identifying specific metrics where improvement would have the greatest impact on overall performance. The system may track changes in the subject's percentile rankings over time to quantify improvement or regression. The aggregate metrics and comparative analysis may be presented through the analyst device 265 in reports, dashboards, or interactive visualizations that enable coaches and analysts to make data-driven decisions about training, recruitment, and player development.

In some embodiments, the functionality described herein as being performed by the client device 205 and the server device 225 may be distributed across any number of computing devices in any suitable configuration. In some embodiments, all processing may be performed locally on a single device, such as a smartphone, tablet, or personal computer, without requiring network communication with a remote server. In such embodiments, the machine learning models and physics-based optimization algorithms may be optimized for on-device execution using techniques such as model quantization, model pruning, knowledge distillation, neural architecture search for efficient architectures, or compilation to specialized hardware accelerators. In alternative embodiments, the processing may be distributed across multiple edge computing devices, with each device performing a portion of the overall processing pipeline. In yet other embodiments, the processing may be distributed across a fog computing layer comprising intermediate computing devices positioned between the client device and the cloud-based server. In some embodiments, the system may dynamically allocate processing tasks between local and remote computing resources based on factors including network latency, network bandwidth availability, battery level of the client device, computational complexity of the current task, or user preferences for privacy and data locality.

In some embodiments, the functionality of the server device 225 and the client device 205 are integrated into a single physical embodiment (e.g., a smartphone) the machine learning model 250 and accompanying data or copies of data may be hosted on a discrete networked device separate from the integrated physical embodiment of the server device 225 and the client device 205. Still further, it is contemplated that the training of the machine learning model 250 may occur on a discrete networked device, and the trained machine learning model 250 may be copied or transferred to the integrated physical embodiment of the server device 225 and the client device 205 for usage by the integrated physical embodiment.

In some embodiments, a summary video 254 can be produced, based upon multiple video segments 214A-D, which can include output metrics 232A-D associated with those video segments 214A, as well as aggregate metrics 251. A summary video 254 can include video segments from a single or multiple subjects 245A-Z.

In some embodiments, the server device can forward the video feed 216 from the camera 207, and optionally include output metrics 232A-D associated with video segments 214A from that video feed 216, as well as aggregate metrics 251.

FIGS. 3A-D depict a projectile analysis protocol 300 in accordance with some embodiments of the present disclosure.

In some embodiments, in block 302 the client device 205 tags key locations, such as the pitcher's mound and home plate. These tagged key locations can be used to determine the absolute positioning of tagged locations including latitude, longitude and altitude, as well as relative positioning between key locations including distance between, difference in height, angular relationships, etc. These key locations can assist in calculating position and therefore velocity and other movement vectors. Tags may be applied manually by a user manipulating the client device 205, or automatically by the client device 205.

In some embodiments, in block 304 a video is captured. In block 306, the client device 205 reviews the frames of the video, and assigns an estimated propulsion stage to each of the one or more frames. In the example of FIG. 1, propulsion stages are stages of human movement corresponding to pitching a baseball, e.g., wind-up, stride, arm cocking, acceleration, deceleration, and follow-through. These propulsion stages may be detected based on components of phyisiology or sub-physiology of the subject, such as a dominant elbow raising in combination with a non-dominant knee falling and stopping (i.e., the stride phase of a baseball pitch.) Other movement types being tracked will have other propulsion stages.

In some embodiments, the assignment of estimated propulsion stages to frames utilizes a pose estimation neural network that detects keypoints corresponding to anatomical landmarks of the human propulsor. For a baseball pitcher, the detected keypoints may include the positions of the head, shoulders, elbows, wrists, hands, hips, knees, ankles, and feet. The temporal sequence of keypoint positions is analyzed to determine the current phase of the pitching motion. The windup phase may be identified by detecting the pitcher raising the lead leg and bringing the hands together near the chest. The stride phase may be identified by detecting the lead leg moving toward the target and the hands separating. The arm cocking phase may be identified by detecting the throwing elbow raised to approximately shoulder height with the forearm externally rotated. The acceleration phase may be identified by detecting rapid internal rotation of the shoulder and extension of the elbow. The deceleration and follow-through phases may be identified by detecting the arm continuing forward and across the body after ball release. In some embodiments, the propulsion stage detection may utilize a recurrent neural network or transformer network that processes the temporal sequence of pose estimates to classify the current phase. In some embodiments, the propulsion stage detection may be performed using a simplified approach that detects specific trigger conditions, such as the throwing hand reaching maximum height (indicating arm cocking) or maximum forward velocity (indicating ball release).

In some embodiments, in block 310, a propulsion initiation frame 212 is determined. The propulsion initiation frame 212 in some examples is a frame containing the point at which the projectile is being propelled; however, in other examples the propulsion initiation frame 212 can be a frame presenting a subject behavior most likely to contingently indicate the projectile has or will be propelled. The selection of the subject behavior may be based on how readily a camera 207 is able to identify the subject behavior, rather than its proximity in time to the propulsion of the projectile. For example, it may be exceedingly difficult for the processor of a smartphone to detect in the video feed 216 a bullet leaving the barrel of a gun in the few frames which would show a bullet—especially if the captured video 210 or video feed 216 is an hours-long video of a hunter waiting for a target. However, it may be relatively easier for the processor of a smartphone to detect a breech or muzzle flash of the firearm before the bullet exits the barrel of the firearm: the smartphone may also be assisted by the use of other sensors, such as a microphone, to detect the sound of the firearm being fired, in identifying the propulsion initiation frame 212. In such examples, the client device 205 is configured to be aware that the frames after, but perhaps not immediately after, the breech or muzzle flash will contain the travelling bullet. Thus, in some embodiments, in blocks 314 and 316, a pre-initiation frame buffer 211 and/or a post-initiation frame buffer 213 are identified.

In some embodiments, in block 316 the buffers 211, 213 and the initiation frame 212 are sequenced to produce a video segment 214A. In block 218, that video segment 214A is sent to the server device 225 over the communications network 299.

In some embodiments, in block 320 the video segment 214A is stabilized, to improve coherency between frames. In block 324, the propulsor (e.g., the baseball pitcher) is identified by the server device 225 in the video segment 214A. In block 326, the video segment, based on the initiation frame 212 and the position of the propulsor can be cropped down to a smaller size in the area within which the projectile is believed to be propelled from.

In some embodiments, the video stabilization process reduces the effects of camera motion and jitter that may occur during the capture of the video segment. The stabilization process may include detecting stable reference points or keypoints within the video frames that are expected to remain stationary throughout the projectile event, such as portions of the playing field, stadium structures, or other background elements. The detected keypoints may be tracked across successive frames using optical flow algorithms, feature matching algorithms, or neural network-based tracking methods. Based on the tracked keypoints, a transformation (such as an affine transformation or a homography) is computed for each frame that maps the frame to a common reference coordinate system, thereby compensating for camera motion. In some embodiments, the transformation is smoothed across frames to avoid introducing artificial jitter. In alternative embodiments, the stabilization may utilize motion data from inertial measurement units (IMUs) in the capture device to estimate and compensate for camera motion. The stabilization process may be performed on-device by the client device 205 or on the server device 225, depending on the computational resources available and the latency requirements of the application.

In some embodiments, in block 328 video distortion is further reduced in the cropped-down sub-frame which is expected to hold the projectile (e.g., baseball). In block 330 the projectile is identified. Blocks 324, 326, 328, and 330 are repeated over some or all of the frames until the earliest frame which depicts the projectile launched and separated from the propulsor is identified (i.e., the baseball pitcher has released the baseball.) In block 332, a post-launch frame buffer is identified, and in some embodiments includes at least enough frames to determine an initial velocity vector of the projectile, and in some embodiments includes at least ten frames. In block 334, the initial projectile coordinates, and an initial projectile velocity vector, are determined.

In some embodiments, blocks 336, 338, 340, and 342 repeat for each subsequent frame until the projectile is determined to have ceased moving in a relevant manner in block 346. In block 342, video distortion is reduced in a sub-frame surrounding the expected or prior coordinates of the projectile. In block 338, the projectile is detected. In block 340, if the projectile has not ceased movement, another movement frame is detected. In block 342, a new set of motion coordinates is determined for the newly-identified movement frame.

In some embodiments, in block 346 the projectile is determined to have ceased movement. As discussed above, this could be based on a period of time with no detected movement having elapsed, the projectile being determined to have entered an area of or outside the frame where movement is deemed to be ceased, or could be based on an expected or unexpected change in trajectory of the projectile. In block 348, the motion coordinates are smoothed. In some embodiments, this can include performing a statistical regression in order to normalize or remove outlier coordinate values. In block 350 the motion coordinates are normalized relative to the perspective of the camera 207. For example, if the projectile is propelled towards the camera 207, and the projectile is a baseball pitch, then the tagged key locations, in some examples along with heuristic timing and knowledge of the design of a baseball field, are utilized to transform coronal motion over time into a 3D trajectory of the projectile.

In block 352, the initial velocity vector is calculated, based on the movement coordinates associated with frames in the post-launch initiation frame buffer of block 332. In some embodiments, the initial velocity vector is used in block 354 to calculate an expected cessation velocity vector, i.e., where the projectile or baseball would have moved to at what velocity but for real-world external phenomena such as the Magnus effect. In block 356, the actual cessation velocity vector is determined, based on some of the projectile coordinate data associated with one or more frames before the projectile cessation was determined in block 346. Based on the difference between the calculated cessation velocity vector and the actual cessation velocity vector, a Magnus effect force vector can be calculated. Continuing the baseball example, a horizontal component of the Magnus effect force vector represents the horizontal break of the baseball pitch, and a vertical component of the Magnus effect force vector represents the vertical break of the baseball pitch.

In some embodiments, in block 360 the movement vectors 213A-D, along with output metrics 232A-N, aggregate metrics 251, summary videos 254, video stream 256, and any other data can be returned to the client device 205 or the analyst device 265 for further review.

In some embodiments, the system implements error handling and graceful degradation mechanisms to maintain functionality when components fail or produce unreliable results. If the ball tracking neural network fails to detect the projectile in a sufficient number of frames to estimate the trajectory, the system may notify the user and request recapture of the projectile event with improved camera positioning or settings. If the second machine learning model produces flight characteristics that fall outside expected physical ranges, the system may flag the results as uncertain and may provide a confidence interval or range of possible values rather than a single point estimate. If the physics-driven optimization algorithm fails to converge to a solution, the system may return the initial estimate from the machine learning model with an indication that the estimate has not been refined. If the network connection between the client device 205 and the server device 225 is interrupted, the client device may buffer captured video segments locally and transmit them when connectivity is restored, or may perform a reduced-accuracy local analysis if the client device is equipped with sufficient computational resources. The system may log errors and degraded performance conditions for later review and may use the collected error data to identify opportunities for system improvement.

FIG. 4 depicts a pitch capture and analysis protocol 400 in accordance with some embodiments of the present disclosure. In some embodiments, in block 405, the client device 205 performs a camera setup and configures capture settings for capturing a video of a projectile event, such as a baseball pitch. The client device 205, which in some embodiments is a smartphone or another camera-enabled device as described with reference to FIG. 2, configures the camera 207 to automatically set capture settings appropriate for high-speed projectile tracking. In some embodiments, the camera 207 is configured to capture video at a frame rate of 240 frames per second (fps), which provides sufficient temporal resolution to track fast-moving projectiles such as a baseball 115 thrown by a baseball pitcher 105. The camera setup may further include configuring a zoom level, such as 1× or 2× optical zoom, and setting a lens position, such as a lens position of approximately 0.75. In some embodiments, the client device 205 is positioned within acceptable capture positions relative to the projectile event, including lateral positions of approximately plus or minus 3 to 10 feet from a centerline, longitudinal positions of approximately 5 to 80 feet behind home plate, and vertical positions of approximately 5 to 25 feet above ground level. These positioning parameters ensure that the camera 207 of the client device 205 has an appropriate field of view and perspective for capturing the trajectory of the projectile, such as the baseball 115 travelling from the pitcher 105 to the catcher 110 as depicted in FIGS. 1A-B.

In some embodiments, the operation of the system produces physical effects and transformations beyond the generation of numerical data. For example, the client device 205 physically adjusts the camera 207 settings, such as the frame rate, exposure time, and focus position, in response to the detected projectile event, thereby configuring the physical imaging hardware in a specific manner optimized for projectile capture. The capture process involves the physical detection of photons by the image sensor of the camera 207 and the physical conversion of the detected photons into electrical signals that are digitized and stored. The processing of the video data by the processors 206, 226 of the client device 205 and server device 225 involves the physical movement of electrons through transistors and the physical storage of data in memory circuits. In some embodiments, the output of the system may be used to control physical devices or to cause physical actions. For example, a pitching machine may be controlled based on the analysis results to simulate specific pitch types for batter training. In another example, a physical display device may be controlled to present a graphical overlay on a live video feed showing the predicted trajectory of the projectile. In yet another example, the analysis results may be used to control a robotic system, such as a robotic catcher or a robotic batting cage.

In some embodiments, in block 410, the client device 205, the server device 225, or a combined integrated device, performs an extrinsic calibration to determine camera position in three-dimensional real-world coordinates relative to a playing field, such as a baseball field. The extrinsic calibration process is driven by artificial intelligence and involves detecting key locations or keypoints on the playing field, such as keypoints associated with the pitcher's mound and home plate. In some embodiments, the extrinsic calibration utilizes a an object detection model, which has been trained to recognize mound and home plate keypoints. The extrinsic calibration process takes the detected keypoints from the field and their known dimensions to match possible camera positions, thereby establishing the spatial relationship between the camera 207 and the playing field. In some embodiments, a fallback to manual tagging is provided if the artificial intelligence-driven keypoint detection does not produce acceptable results, similar to the tagging of key locations described with reference to block 302 of FIGS. 3A-D, wherein a user manipulates the client device 205 to manually tag key locations such as the pitcher's mound and home plate. The extrinsic calibration further includes a perspective-n-point (PnP) calibration process to calculate the camera position in three-dimensional real-world coordinates relative to the baseball field. The tagged key locations and the determined camera position can be used to determine absolute positioning including latitude, longitude, and altitude, as well as relative positioning between key locations including distance between locations, difference in height, and angular relationships, which can assist in calculating position and therefore velocity and other movement vectors 231A-D.

In some embodiments, in block 415, the client device 205 captures a video of a projectile event, such as a baseball pitch. The video is captured at a resolution of 1080p and a frame rate of 240 frames per second. The captured video 210, as described with reference to FIG. 2, is produced by the camera 207 of the client device 205 and stored in the memory 209 of the client device 205. The high frame rate of 240 frames per second provides sufficient temporal resolution to capture the rapid movement of a baseball 115 as it travels from the pitcher 105 to the catcher 110, spanning the time from T0 to T6 as depicted in FIGS. 1A-B. In some embodiments, the client device 205 captures video continuously or for an extended duration, such as a multi-hour practice session, which may contain multiple projectile events.

Although the specification describes video captured at 1080p resolution and 240 frames per second as disclosed parameters, the system and method are operable with video captured at a wide range of resolutions and frame rates. In some embodiments, the video may be captured at resolutions including, but not limited to, 720p (1280×720 pixels), 1080p (1920×1080 pixels), 1440p (2560×1440 pixels), 4K (3840×2160 pixels), or 8K (7680×4320 pixels). In some embodiments, the video may be captured at frame rates including, but not limited to, 24 fps, 30 fps, 60 fps, 120 fps, 240 fps, 480 fps, 960 fps, or higher frame rates up to and including ultra-high-speed capture rates exceeding one million frames per second for specialized applications. In some embodiments, the system may dynamically adjust the resolution and frame rate based on available device capabilities, network bandwidth, storage capacity, or the specific characteristics of the projectile event being captured. For example, a faster-moving projectile may require a higher frame rate for accurate tracking, while a slower-moving projectile may be adequately captured at a lower frame rate. In some embodiments, the video may be captured in various color spaces and bit depths, including 8-bit, 10-bit, 12-bit, or higher bit depths per channel, and in various color formats including YUV, RGB, or raw sensor data formats.

In some embodiments, in block 420, the client device 205 automatically determines when a pitch or other projectile event is occurring within the captured video 210 using a video action recognition model. The video action recognition model may be a video-action recognition model or another suitable neural network model trained to recognize pitching actions or other projectile propulsion events. In some embodiments, the video action recognition process includes cropping a region of interest around an indicator displayed on a user interface of the client device 205, and creating windows of a predetermined number of frames, such as windows of 50 frames, which are fed to the video action recognition model for inference. The inference may be performed approximately two times per second or at another suitable rate. When the video action recognition model outputs a probability exceeding a threshold, such as a probability greater than 0.51, a pitch or projectile event is triggered. The automatic determination of when a pitch is occurring is analogous to the assignment of estimated propulsion stages to one or more frames described with reference to block 306 of FIG. 3A, wherein propulsion stages of human movement corresponding to pitching a baseball are detected, such as wind-up, stride, arm cocking, acceleration, deceleration, and follow-through.

In some embodiments, in block 425, upon triggering of a pitch or projectile event, a predetermined number of frames are captured and stored locally in the memory 209 of the client device 205. In some embodiments, 480 frames are captured, which at 240 frames per second corresponds to a two-second duration. This captured segment constitutes a video segment 214A as described with reference to FIG. 2, and includes frames corresponding to the propulsion initiation frame 212, the pre-frame buffer 211, and the post-frame buffer 213. The captured frames are sent through a preprocessing pipeline that is accelerated by a graphics processing unit (GPU) of the client device 205, such as an iOS GPU or another suitable GPU. The preprocessing pipeline includes cropping, resizing, letterboxing, floating-point 16-bit conversion, and color space conversion from BGRA to RGB format. The preprocessing pipeline further includes batch packing windows for subsequent ball tracking, wherein consecutive frame windows (such as windows of three consecutive frames) are prepared and batched together (such as in batches of eight windows), thereby creating multiple batches for processing (such as 60 batches).

The preprocessing pipeline executed by the client device 205 represents a non-conventional arrangement of computing components that improves the technical performance of the projectile detection process. The acceleration of the preprocessing pipeline by the graphics processing unit (GPU) of the client device, rather than the central processing unit (CPU), enables parallel processing of multiple frame transformations simultaneously, resulting in processing speeds that are orders of magnitude faster than would be achievable using only the CPU. The specific sequence of preprocessing operations, including cropping, resizing, letterboxing, floating-point 16-bit conversion, and color space conversion from BGRA to RGB format, is tailored to the input requirements of the ball tracking neural network and is optimized to minimize memory bandwidth consumption and processing latency on the specific GPU architecture. The batch packing of consecutive frame windows enables efficient utilization of the parallel processing capabilities of the GPU by presenting multiple inference operations in a single batched invocation of the neural network. This non-conventional combination of GPU-accelerated preprocessing, optimized operation sequence, and batch packing enables real-time or near-real-time ball tracking on consumer devices that would otherwise be incapable of performing such computationally intensive analysis

In some embodiments, in block 430, a ball tracking neural network is utilized to detect and track the projectile, such as the baseball 115, within the captured frames. The ball tracking neural network may be an object tracking model or another suitable neural network model trained for tracking a baseball or other projectile. In some embodiments, the ball tracking neural network processes the batched frame windows locally on the client device 205, such as processing 60 batches of 8 window packs in approximately 10 seconds. The ball tracking neural network outputs, for each of the captured frames (such as 480 frames), the frame identifier, ball coordinates, and a confidence level indicating the reliability of the detected ball position. The detection of the projectile in block 430 is analogous to the detection of the projectile described with reference to blocks 330 and 338 of FIGS. 3B-C, wherein the projectile is identified in the frames of the video segment 214A. The ball coordinates output by the ball tracking neural network correspond to the projectile coordinates 230A-N stored in the memory 229 of the server device 225 as described with reference to FIG. 2.

In some embodiments, the ball tracking neural network is trained to detect the projectile under adverse conditions that commonly occur in real-world usage. Adverse conditions may include partial occlusion of the projectile by the pitcher's body, the catcher's glove, or other objects; motion blur that distorts the appearance of the projectile at high velocities; varying illumination conditions including bright sunlight, artificial lighting, shadows, and low-light environments; background clutter including spectators, advertisements, and complex stadium architecture; and weather conditions such as rain, snow, or fog. To improve robustness to these adverse conditions, the training data for the ball tracking neural network may include examples captured under or synthesized to represent a wide variety of conditions. Data augmentation techniques may be applied during training to expose the neural network to variations in brightness, contrast, saturation, noise level, blur amount, and partial occlusion. In some embodiments, the neural network architecture may incorporate attention mechanisms that enable the network to focus on the most relevant portions of the input frames. In some embodiments, the neural network may output a confidence score for each detection, and detections with low confidence may be handled differently in the post-processing stage, such as by applying a higher smoothing weight from the Kalman filter.

In some embodiments, in block 435, post-processing is performed on the output of the ball tracking neural network to convert noisy ball tracking output to a clean ball trajectory. The post-processing includes applying a Kalman filter to the ball coordinates to reduce noise and improve trajectory estimation. The post-processing further includes gated growth, outlier rejection, gap infilling, and linear interpolation to produce a continuous and reliable ball trajectory. Additionally, the post-processing includes trajectory choosing, which determines where in the output the pitch or projectile event actually occurred, leveraging median absolute deviation from general movement to identify the relevant portion of the trajectory. The post-processing of block 435 is analogous to the smoothing of the one or more projectile motion coordinates described with reference to block 348 of FIG. 3D, which may include performing a statistical regression to normalize or remove outlier coordinate values. The resulting clean ball trajectory provides the input for subsequent estimation of flight characteristics and physics-based refinement.

In some embodiments, the Kalman filter applied to the ball coordinates is a discrete-time linear Kalman filter or an extended Kalman filter configured to estimate the state of the projectile in the image plane. The state vector of the Kalman filter may include the two-dimensional position of the projectile in image coordinates, the two-dimensional velocity of the projectile in image coordinates, and optionally the two-dimensional acceleration of the projectile in image coordinates. The Kalman filter process model may assume constant velocity or constant acceleration motion between frames, or assume known deceleration based on assumed conditions, with process noise accounting for deviations from the assumed motion model. The Kalman filter measurement model may relate the true projectile state to the noisy ball coordinates output by the ball tracking neural network, with measurement noise parameters estimated from the confidence levels output by the neural network or determined empirically based on the characteristics of the neural network. In some embodiments, the Kalman filter may be initialized when a new projectile trajectory is detected and may be updated with each new ball coordinate observation. When the ball tracking neural network fails to detect the projectile in a particular frame, the Kalman filter may propagate the state estimate using only the process model, thereby providing gap infilling functionality. Outlier rejection may be implemented by comparing each new observation to the predicted state from the Kalman filter and rejecting observations that deviate from the predicted state by more than a predetermined number of standard deviations based on the predicted covariance. In some embodiments, linear interpolation may be applied to fill gaps that persist after Kalman filtering by computing weighted averages of the estimated positions before and after the gap.

In some embodiments, in block 437, a custom model and associated training data are utilized to enhance the accuracy and robustness of the ball tracking and trajectory estimation. The custom model may include a transformer encoder architecture with rotary position embedding (RoPE), comprising multiple layers (such as six layers), a specified dimensionality (such as 256 dimensions), and multiple attention heads (such as four attention heads). In some embodiments, a custom dataset is generated for training the custom model, wherein the custom dataset includes synthetic pitches generated using aerodynamic and physics-based processes. The synthetic pitch generation samples from distributions spanning high school, collegiate, and professional pitching attributes, thereby providing a diverse training dataset representative of various skill levels. The synthetic pitch generation further includes simulating different camera positions by moving a simulated camera within target regions corresponding to the acceptable capture positions described with reference to block 405, as well as noise injection to improve model robustness. The custom model trained on the generated training data may be utilized by the machine learning model 250 stored in the memory 229 of the server device 225 as described with reference to FIG. 2, or may be deployed locally on the client device 205.

The synthetic pitch generation process simulates realistic baseball pitch trajectories by sampling initial conditions from distributions that span the range of human pitching capabilities. The initial velocity magnitude may be sampled from a distribution ranging from approximately 50 miles per hour (typical of youth or beginning pitchers) to approximately 105 miles per hour (typical of elite professional pitchers). The release point may be sampled from distributions representing the range of release heights (typically 5 to 7 feet above the ground), horizontal offsets (typically 1 to 3 feet from the center of the rubber), and extensions (typically 4 to 7 feet in front of the rubber). The spin rate may be sampled from a distribution ranging from approximately 1000 revolutions per minute to approximately 3500 revolutions per minute. The spin axis may be sampled to represent various pitch types, including four-seam fastballs (predominantly backspin), curveballs (predominantly topspin), sliders (gyroscopic or sidespin), and changeups (varied spin characteristics). For each sampled set of initial conditions, the synthetic trajectory is computed by numerically integrating the equations of motion using a method such as fourth-order Runge-Kutta integration, with time steps sufficiently small (such as 0.001 seconds or smaller) to ensure numerical accuracy. The computed three-dimensional trajectory is then projected onto the image plane using camera parameters sampled from the range of acceptable capture positions, thereby generating the two-dimensional trajectory that serves as input to the model. Noise is injected into the two-dimensional trajectory to simulate the noise characteristics of the ball tracking neural network, and the noisy trajectory is paired with the ground truth flight characteristics to form a training example.

Although specific neural network architectures have been described herein as examples, one of ordinary skill in the art will appreciate that the first machine learning model and the second machine learning model may each be implemented using any suitable neural network architecture or combination of architectures. Alternative architectures for the first machine learning model, which performs object detection and tracking, may include convolutional neural networks (CNNs), recurrent neural networks (RNNs), long short-term memory (LSTM) networks, gated recurrent unit (GRU) networks, attention-based networks, graph neural networks, capsule networks, or hybrid architectures combining multiple network types. Alternative architectures for the second machine learning model, which estimates flight characteristics, may include multilayer perceptrons (MLPs), encoder-decoder networks, variational autoencoders (VAEs), generative adversarial networks (GANs), diffusion models, or any other neural network architecture capable of learning the mapping from two-dimensional projectile trajectories to three-dimensional flight characteristics. In some embodiments, the machine learning models may be implemented as ensemble models that combine predictions from multiple individual models using techniques such as averaging, weighted voting, stacking, or boosting. In some embodiments, the machine learning models may be trained using supervised learning, semi-supervised learning, self-supervised learning, unsupervised learning, reinforcement learning, or combinations thereof. The training process may utilize data augmentation techniques including, but not limited to, rotation, scaling, cropping, color jittering, noise injection, time warping, and synthetic data generation.

In some embodiments, in block 440, an estimation of rough seed flight characteristics is performed using a custom transformer-based neural network. The custom transformer-based neural network estimates flight characteristics of the projectile based on the post-processed ball trajectory. In some embodiments, the inputs to the custom transformer-based neural network include tokenized ball locations comprising an array of two-dimensional pixel coordinates from the post-processed trajectory, and an array of timestamps relating to the ball positions. The inputs further include camera parameters comprising: an intrinsic matrix K (a 3×3 matrix), distortion coefficients D, a rotation matrix R (a 3×3 matrix calculated from the extrinsic calibration of block 410), and a camera position C_world in world coordinates (also calculated from the extrinsic calibration of block 410). In some embodiments, the outputs of the custom transformer-based neural network include an 11-dimensional initial state vector theta comprising physics parameters that describe ball flight. The 11-dimensional initial state vector includes initial position components (x0, y0, z0), initial velocity components (vx0, vy0, vz0), spin axis information (sx, sy, sz), a spin efficiency factor (eta), and a spin rate (omega). The outputs may further include a confidence score indicating the reliability of the estimated flight characteristics. The initial velocity components (vx0, vy0, vz0) correspond to the initial velocity vector determined in block 334 of FIG. 3B and calculated in block 352 of FIG. 3D.

In some embodiments, the transformer encoder architecture processes the projectile trajectory as a sequence of input tokens, wherein each token corresponds to a frame or a small window of frames and encodes the two-dimensional projectile coordinates and optionally additional features derived from the image data or the camera parameters. The input tokens may be linearly projected to the model dimension (such as 256 dimensions) using a learned linear embedding layer. Rotary position embedding (RoPE) is applied to the embedded tokens to encode positional information in a manner that enables the model to generalize to trajectories of varying lengths. Each layer of the transformer encoder comprises a multi-head self-attention sublayer and a feed-forward network sublayer, with residual connections and layer normalization applied around each sublayer. The multi-head self-attention sublayer allows the model to attend to relationships between different portions of the trajectory, enabling the model to learn patterns such as the characteristic curvature induced by the Magnus effect. The feed-forward network sublayer applies two linear transformations with a nonlinear activation function, such as GELU or ReLU, between them. The output of the final transformer encoder layer is pooled, such as by averaging or by selecting the output corresponding to a designated classification token, and the pooled representation is passed through one or more fully connected layers to produce the estimated flight characteristics. In some embodiments, the model is trained using a mean squared error loss between the predicted flight characteristics and the ground truth flight characteristics derived from the synthetic training data. The training process may employ techniques such as dropout regularization, weight decay, learning rate scheduling, and early stopping to improve generalization performance.

In some embodiments, in block 445, physics-driven refinement is performed on the seed flight characteristics using an optimization algorithm. The optimization algorithm may be a Levenberg-Marquardt algorithm or another suitable nonlinear least-squares optimization algorithm. The physics-driven refinement refines the seed parameters based on distance from the seed estimate, two-dimensional pixel reprojection errors, physical flight kinematics, and time-of-flight constraints. In some embodiments, the inputs to the physics-driven refinement include the seed parameters from block 440, the camera parameters from block 410, timestamps, and pixel coordinates. The output of the physics-driven refinement is a final 11-dimensional refined state vector that accurately describes the flight of the ball. The physics-driven refinement of block 445 is analogous to the normalization of the one or more projectile motion coordinates described with reference to block 350 of FIG. 3D, wherein the motion coordinates are normalized relative to the perspective of the camera 207 and transformed into a three-dimensional trajectory.

In some embodiments, the physics-driven optimization algorithm implements an iterative refinement process that minimizes a combined loss function comprising multiple components. The combined loss function may include a reprojection error component that measures the difference between the observed two-dimensional projectile positions in the image frames and the two-dimensional positions that would result from projecting the estimated three-dimensional trajectory back onto the image plane using the determined camera parameters. The combined loss function may further include a physics consistency component that measures deviation from expected projectile behavior according to aerodynamic principles, including the effects of gravity, air resistance (drag), and the Magnus effect. The physics consistency component may be formulated based on the equations of motion for a spinning sphere traveling through a fluid medium, wherein the acceleration of the projectile is expressed as the sum of gravitational acceleration, drag acceleration proportional to the square of the velocity and inversely proportional to the mass, and Magnus acceleration proportional to the cross product of the spin vector and the velocity vector. The combined loss function may additionally include a time-of-flight constraint that enforces consistency between the estimated trajectory and the observed time required for the projectile to travel from its initial position to its final position. In some embodiments, the optimization algorithm may be implemented using gradient-based optimization methods such as gradient descent, stochastic gradient descent, Adam, RMSprop, or L-BFGS. In alternative embodiments, the optimization algorithm may be implemented using derivative-free optimization methods such as Nelder-Mead, Powell's method, differential evolution, particle swarm optimization, or genetic algorithms. The optimization algorithm may terminate when the combined loss function falls below a predetermined threshold, when the change in the loss function between successive iterations falls below a predetermined threshold, or when a maximum number of iterations has been reached.

In some embodiments, in block 450, physics-based pitch integration is performed using the refined 11-dimensional state vector to compute a complete three-dimensional pitch trajectory. The physics-based pitch integration leverages the refined state vector, which includes initial position, initial velocity, spin axis information, spin efficiency, and spin rate, to integrate the equations of motion describing the projectile flight. The integration accounts for aerodynamic forces acting on the spinning projectile, including the Magnus force, which is a lateral force that acts on a spinning object (such as a baseball 115) moving through a fluid or gas as described with reference to FIG. 1B. The output of the physics-based pitch integration is a complete three-dimensional pitch trajectory describing the path of the baseball 115 from the point of release by the pitcher 105 to the point of cessation at or near the catcher 110.

In some embodiments, in block 455, pitch metrics are calculated from the three-dimensional pitch trajectory. The calculated pitch metrics include velocity, which corresponds to the initial velocity vector calculated in block 352 of FIG. 3D. The calculated pitch metrics further include induced vertical break and horizontal break, which correspond to components of the Magnus force vector calculated in block 358 of FIG. 3D. In some embodiments, the induced vertical break represents the vertical component of the Magnus effect force vector, describing the vertical break of the baseball pitch, while the horizontal break represents the horizontal component of the Magnus effect force vector, describing the horizontal break of the baseball pitch. The calculated pitch metrics further include vertical and horizontal approach angles, release location (including side position, extension, and height), and plate location (including side position and height). The release location metrics correspond to the release height and extension movement vectors described above, and the plate location metrics correspond to the pitch zone location movement vectors described above. The calculated pitch metrics constitute output metrics 232A-N as described with reference to FIG. 2, and may be transmitted over the communications network 299 to the analyst device 265 or returned to the client device 205 for further review, in accordance with block 360 of FIG. 3D.

In some embodiments, the system provides real-time or near-real-time feedback to users based on the calculated pitch metrics. The feedback may be presented visually on the display of the client device 205 or analyst device 265 as overlays on the video, as graphical representations of the trajectory, or as numerical displays of the metrics. The feedback may be presented aurally through speakers or headphones, such as by speaking the velocity value immediately after each pitch is captured. The feedback may be presented haptically through vibrations or other tactile feedback on the client device. In some embodiments, the system may provide comparative feedback that compares the metrics of the current pitch to historical metrics for the same subject, to aggregate metrics across multiple subjects, or to target metrics specified by a coach or analyst. The comparative feedback may indicate whether performance is improving, declining, or remaining stable over time. In some embodiments, the system may provide predictive feedback that uses the machine learning model 250 to predict future performance based on current trends or to recommend training interventions to achieve desired performance improvements.

FIG. 5 is a block diagram that illustrates an example computer system with which an embodiment can be implemented. In the example of FIG. 5, a computer system 500 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 500 includes an input/output (I/O) subsystem 502 which can include a bus and/or other communication mechanism(s) for communicating information and/or instructions between the components of the computer system 500 over electronic signal paths. The I/O subsystem 502 can include an I/O controller, a memory controller and at least one I/O port. The electronic signal paths are represented schematically in the drawings, for example as lines, unidirectional arrows, or bidirectional arrows.

At least one hardware processor 504 is coupled to I/O subsystem 502 for processing information and instructions. Hardware processor 504 can include, for example, a general-purpose microprocessor or microcontroller and/or a special-purpose microprocessor such as an embedded system or a graphics processing unit (GPU) or a digital signal processor or Advanced Reduced Instruction Set Computer (RISC) Machine (ARM) processor. Processor 504 can comprise an integrated arithmetic logic unit (ALU) or can be coupled to a separate ALU.

Computer system 500 includes one or more units of memory 506, such as a main memory, which is coupled to I/O subsystem 52 for electronically digitally storing data and instructions to be executed by processor 504. Memory 506 can include volatile memory such as various forms of random-access memory (RAM) or other dynamic storage device. Memory 506 also can be used for storing temporary variables or other intermediate information during execution of instructions to be executed by processor 504. Such instructions, when stored in non-transitory computer-readable storage media accessible to processor 504, can render computer system 500 into a special-purpose machine that is customized to perform the operations specified in the instructions.

Computer system 500 further includes non-volatile memory such as read only memory (ROM) 508 or other static storage device coupled to I/O subsystem 502 for storing information and instructions for processor 504. The ROM 508 can include various forms of programmable ROM (PROM) such as erasable PROM (EPROM) or electrically erasable PROM (EEPROM). A unit of persistent storage 510 can include various forms of non-volatile RAM (NVRAM), such as flash memory, or solid-state storage, magnetic disk, or optical disk such as CD-ROM or DVD-ROM, and can be coupled to I/O subsystem 502 for storing information and instructions. Storage 510 is an example of a non-transitory computer-readable medium that can be used to store instructions and data which when executed by the processor 504 cause performing computer-implemented methods to execute the techniques herein.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The instructions in memory 506, ROM 508 or storage 510 can comprise one or more sets of instructions that are organized as modules, methods, objects, functions, routines, or calls. The instructions can be organized as one or more computer programs, operating system services, or application programs including mobile apps. The instructions can comprise an operating system and/or system software; one or more libraries to support multimedia, programming or other functions; data protocol instructions or stacks to implement Transmission Control Protocol/Internet Protocol (TCP/IP), Hypertext Transfer Protocol (HTTP) or other communication protocols; file processing instructions to interpret and render files coded using HTML, Extensible Markup Language (XML), Joint Photographic Experts Group (JPEG), Moving Picture Experts Group (MPEG) or Portable Network Graphics (PNG); user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. The instructions can implement a web server, web application server or web client. The instructions can be organized as a presentation layer, application layer and data storage layer such as a relational database system using structured query language (SQL) or NoSQL, an object store, a graph database, a flat file system or other data storage.

Computer system 500 can be coupled via I/O subsystem 502 to at least one output device 512. In one embodiment, output device 512 is a digital computer display. Examples of a display that can be used in various embodiments include a touch screen display or a light-emitting diode (LED) display or a liquid crystal display (LCD) or an e-paper display. Computer system 500 can include other type(s) of output devices 512, alternatively or in addition to a display device. Examples of other output devices 512 include printers, ticket printers, plotters, projectors, sound cards or video cards, speakers, buzzers or piezoelectric devices or other audible devices, lamps or LED or LCD indicators, haptic devices, actuators, or servos.

At least one input device 514 is coupled to I/O subsystem 502 for communicating signals, data, command selections or gestures to processor 504. Examples of input devices 514 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 516, which can perform cursor control or other automated control functions such as navigation in a graphical interface on a display screen, alternatively or in addition to input functions. Control device 516 can be a touchpad, a mouse, a trackball, or cursor direction keys for communicating direction information and command selections to processor 504 and for controlling cursor movement on the output device 512. The input device can have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 514 can include a combination of multiple different input devices, such as a video camera and a depth sensor.

In another embodiment, computer system 500 can comprise an internet of things (IoT) device in which one or more of the output device 512, input device 514, and control device 516 are omitted. Or, in such an embodiment, the input device 514 can comprise one or more cameras, motion detectors, thermometers, microphones, seismic detectors, other sensors or detectors, measurement devices or encoders and the output device 512 can comprise a special-purpose display such as a single-line LED or LCD display, one or more indicators, a display panel, a meter, a valve, a solenoid, an actuator or a servo.

When computer system 500 is a mobile computing device, input device 514 can comprise a global positioning system (GPS) receiver coupled to a GPS module that is capable of triangulating to a plurality of GPS satellites, determining and generating geo-location or position data such as latitude-longitude values for a geophysical location of the computer system 500. Output device 512 can include hardware, software, firmware, and interfaces for generating position reporting packets, notifications, pulse or heartbeat signals, or other recurring data transmissions that specify a position of the computer system 500, alone or in combination with other application-specific data, directed toward host computer 524 or server 530.

Computer system 500 can implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 500 in response to processor 504 executing at least one sequence of at least one instruction contained in main memory 506. Such instructions can be read into main memory 506 from another storage medium, such as storage 510. Execution of the sequences of instructions contained in main memory 506 causes processor 504 to perform the process steps described herein. In alternative embodiments, hard-wired circuitry can be used in place of or in combination with software instructions.

The term “storage media” as used herein refers to any non-transitory media that store data and/or instructions that cause a machine to operate in a specific fashion. Such storage media can comprise non-volatile media and/or volatile media. Non-volatile media includes, for example, optical or magnetic disks, such as storage 510. Volatile media includes dynamic memory, such as memory 505. Common forms of storage media include, for example, a hard disk, solid state drive, flash drive, magnetic data storage medium, any optical or physical data storage medium, memory chip, or the like.

Storage media is distinct from but can be used in conjunction with transmission media. Transmission media participates in transferring information between storage media. For example, transmission media includes coaxial cables, copper wire and fiber optics, including the wires that comprise a bus of I/O subsystem 502. Transmission media can also take the form of acoustic or light waves, such as those generated during radio-wave and infra-red data communications.

Various forms of media can be involved in carrying at least one sequence of at least one instruction to processor 504 for execution. For example, the instructions can initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 500 can receive the data on the communication link and convert the data to be read by computer system 500. For instance, a receiver such as a radio frequency antenna or an infrared detector can receive the data carried in a wireless or optical signal and appropriate circuitry can provide the data to I/O subsystem 502 such as place the data on a bus. I/O subsystem 502 carries the data to memory 505, from which processor 504 retrieves and executes the instructions. The instructions received by memory 505 can optionally be stored on storage 510 either before or after execution by processor 504.

Computer system 500 also includes a communication interface 518 coupled to I/O subsystem 502. Communication interface 518 provides a two-way data communication coupling to network link(s) 520 that are directly or indirectly connected to at least one communication network, such as a network 522 or a public or private cloud on the Internet. For example, communication interface 518 can be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 522 broadly represents a LAN, WAN, campus network, internetwork, or any combination thereof. Communication interface 518 can comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 518 sends and receives electrical, electromagnetic, or optical signals over signal paths that carry digital data streams representing various types of information.

Computer system 500 can also include a timer 532. The processor 504 can initiate the timer 532 to expire after an interval of time (e.g., 1 second, 1 minute, 10 minutes, etc.). In some embodiments, the processor 504 received an interrupt upon expiration of the timer 532. The processor 504 can, for instance, execute an interrupt service routine (ISR) in response to the interrupt. In some embodiments, the interrupt signals to the processor 504 that a task has failed to complete execution within a time interval that the timer 532 was initiated with.

Network link 520 typically provides electrical, electromagnetic, or optical data communication directly or through at least one network to other data devices, using, for example, satellite, cellular, Wi-Fi, or BLUETOOTH technology. For example, network link 520 can provide a connection through a network 522 to a host computer 524.

Furthermore, network link 520 can provide a connection through network 522 or to other computing devices via internetworking devices and/or computers that are operated by an Internet Service Provider (ISP) 525. ISP 525 provides data communication services through a world-wide packet data communication network represented as internet 528. To ensure data security and privacy, network communications may be encrypted using Transport Layer Security (TLS), Secure/Multipurpose Internet Mail Extensions (S/MIME), or other cryptographic methods. Network devices such as firewalls, intrusion detection/prevention systems (IDS/IPS), and proxy servers may be deployed to protect computer system 500 components from unauthorized access or cyber threats.

A server 530 can be coupled to internet 528. Server 530 broadly represents any computer, data center, virtual machine, or virtual computing instance with or without a hypervisor, or computer executing a containerized program system such as DOCKER or KUBERNETES. Server 530 can represent an electronic digital service that is implemented using more than one computer or instance and that is accessed and used by transmitting web services requests, uniform resource locator (URL) strings with parameters in HTTP payloads, application programming interface (API) calls, app services calls, or other service calls. Computer system 500 and server 530 can form elements of a distributed computing system that includes other computers, a processing cluster, server farm or other organization of computers that cooperate to perform tasks or execute applications or services. Server 530 can comprise one or more sets of instructions that are organized as modules, methods, objects, functions, routines, or calls. The instructions can be organized as one or more computer programs, operating system services, or application programs including mobile apps. The instructions can comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a GUI, command-line interface or text user interface; application software such as an office suite, internet access applications, design and manufacturing applications, graphics applications, audio applications, software engineering applications, educational applications, games or miscellaneous applications. Server 530 can comprise a web application server that hosts a presentation layer, application layer and data storage layer such as a relational database system using structured query language (SQL) or NoSQL, an object store, a graph database, a flat file system or other data storage.

Computer system 500 can send messages and receive data and instructions, including program code, through the network(s), network link 520 and communication interface 518. In the Internet example, a server 530 might transmit a requested code for an application program through Internet 528, ISP 525, local network 522 and communication interface 518. The received code can be executed by processor 504 as it is received, and/or stored in storage 510, or other non-volatile storage for later execution.

The execution of instructions as described in this section can implement a process in the form of an instance of a computer program that is being executed and consisting of program code and its current activity. Depending on the operating system (OS), a process can be made up of multiple threads of execution that execute instructions concurrently. In this context, a computer program is a passive collection of instructions, while a process can be the actual execution of those instructions. Several processes can be associated with the same program; for example, opening up several instances of the same program often means more than one process is being executed. Multitasking can be implemented to allow multiple processes to share processor 504. While each processor 504 or core of the processor executes a single task at a time, computer system 500 can be programmed to implement multitasking to allow each processor to switch between tasks that are being executed without having to wait for each task to finish. In an embodiment, switches can be performed when tasks perform input/output operations, when a task indicates that it can be switched, or on hardware interrupts. Time-sharing can be implemented to allow fast response for interactive user applications by rapidly performing context switches to provide the appearance of concurrent execution of multiple processes simultaneously. In an embodiment, for security and reliability, an operating system can prevent direct communication between independent processes, providing strictly mediated and controlled inter-process communication functionality.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to, subscriber systems 105-107, alternative trading system 120, matching engine 125, market execution rating system 133, clearing house 135, and trade reporting facility 140 can be implemented as one or more computer programs, i.e., one or more modules of computer program instructions encoded on a tangible non-transitory program carrier for execution by, or to control the operation of, a data processing apparatus (or a computer system). According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++), procedural programming languages (e.g., C or assembly language), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate functionality described herein.

FIG. 6 illustrates components of an exemplary querying computing environment 600, in accordance with some exemplary embodiments. For example, computing environment 600 may include one or more source systems 602, and one or more model-querying systems 630, which connect to machine learning model 250. In some instances, each of machine learning model 250, source systems 602, and model-querying system 630 may be interconnected through one or more communications networks, such as communications network 620. Examples of communications network 620 include, but are not limited to, a wireless local area network (LAN), e.g., a “Wi-Fi” network, a network utilizing radio-frequency (RF) communication protocols, a Near Field Communication (NFC) network, a wireless Metropolitan Area Network (MAN) connecting multiple wireless LANs, and a wide area network (WAN), e.g., the Internet. Communications networks 620 may be the same network, separate networks, overlapping networks, or one may be a virtual communications network running within the other communications network.

In some examples, each of machine learning model 250, source systems 602, and model-querying system 630 may represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of machine learning model 250, source systems 602, and model-querying system 630 may also include a communications interface, such as one or more wireless transceivers, coupled to the one or more processors for accommodating wired or wireless internet communication with other computing systems and devices operating within computing environment 600.

Further, in some instances, machine learning model 250, source systems 602, and model-querying system 630 may each be incorporated into a respective, discrete computing system. In additional or alternative instances, one or more of machine learning model 250, source systems 602, and model-querying system 630 may correspond to a distributed computing system having a plurality of interconnected, computing components distributed across an appropriate computing network, such as communications network 620. For example, model-querying system 630 may correspond to a distributed or cloud-based computing cluster associated with and maintained by the financial institution, although in other examples, machine learning model 250 or model-querying system 630 may correspond to a publicly accessible, distributed or cloud-based computing cluster, such as a computing cluster maintained by Microsoft Azure™, Amazon Web Services™, Google Cloud™, or another third-party provider.

In some instances, machine learning model 250 and model-querying system 630 may include a plurality of interconnected, distributed computing components, such as those described herein (but not necessarily illustrated), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of machine learning model 250 or model-querying system 630 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Each of source systems 602 may maintain, within corresponding tangible, non-transitory memories, a data repository that includes confidential data. For example, one or more of source systems 602 may be associated with, or operated by, a sporting club, and may maintain, within one or more tangible, non-transitory memories, a source data repository that includes source data tables identifying or characterizing current or prospective athletic members of the sporting club, the athletic performance data (e.g., batting, pitching, weight-training) and goals of athletic members, as well as interactions between these athletic members and the sporting club, such as, but are not limited to, data tables that maintain elements of athletic member profile data, individual performance data, team performance data, coaching data, and historical performance data that identify and characterize the athletic member and their relationships or interactions with the sporting club and other sporting clubs, some of which may be obtained by the machine learning model 250, client device 205, and third-party recordation devices.

The source data repository may also include source data tables identifying historical, current, and projected performance of some or all of the current or prospective athletic members of the sporting club, including pitch data, such as pitch trajectory data and flight characteristics, and pitch metrics. The source data tables 604 may also include synthetic pitch data, such as synthetic pitch trajectory data and flight characteristics, and synthetic pitch metrics.

Model-querying system 630 may perform operations that establish and maintain one or more centralized data repositories within corresponding ones of the tangible, non-transitory memories. For example, as illustrated in FIG. 6, model-querying system 630 may establish a consolidated data store 632, which maintains, among other things, consolidated vectorized elements (e.g., data tables) of the athlete data, athletic performance data, as well as synthetic athletic performance data, as discussed above.

In some instances, model-querying system 630 may perform any of the exemplary processes described herein to ingest source data tables that include athlete data or athletic performance data related to client device 205 or server device 225 at one or more of source systems 602 (e.g., in accordance with a predetermined schedule, or in real-time on a streaming basis, etc.), and to apply one or more pre-processing operations to the source data tables, and to generated corresponding, athlete-specific cand athletic performance-specific consolidated data tables that include vectorized elements of the pre-processed athlete data, athletic performance data, and data related to client device 205 or server device 225. Consolidated data store 632 may, for instance, correspond to a data lake, a data warehouse, or another centralized repository established and maintained, respectively, by the distributed components of model-querying system 630, e.g., through a distributed file system (DFS).

For example, model-querying system 630 may execute one or more application programs, elements of code, or code modules that, in conjunction with the corresponding communications interface, establish a secure, programmatic channel of communication with each of source systems 602, and may perform operations that access and obtain all, or a selected portion, of the elements of athlete data, athletic performance data, and data related to client device 205 or server device 225 maintained by corresponding ones of source systems 602. As illustrated in FIG. 6, each of source systems 602 may perform operations that obtain one or more of source data tables 604, including the data elements of athlete data, athletic performance data, and data related to client device 205 or server device 225 from corresponding data repositories, and that transmit corresponding ones of source data tables 604 across communications network 620 to model-querying system 630. In some instances, each of source systems 602 may perform operations that transmit respective ones of source data tables 604 across communications network 620 to model-querying system 630 in batch form and in accordance with a predetermined temporal schedule (e.g., on a daily basis, on a monthly basis, etc.), or in real-time on a continuous, streaming basis.

In some embodiments, the system implements privacy-preserving mechanisms to protect sensitive data while enabling analysis and aggregation. The video data and output metrics may be encrypted during transmission over the communications network 299 using encryption protocols such as TLS 1.3 or other secure communication protocols. The video data and output metrics may be encrypted at rest in the memories of the client device 205, server device 225, and analyst device 265 using encryption algorithms such as AES-256. In some embodiments, the system may implement differential privacy techniques that add calibrated noise to aggregated metrics to prevent inference of individual data from aggregate reports. In some embodiments, the system may implement federated learning techniques that train or update the machine learning models using data distributed across multiple client devices without requiring the raw data to be transmitted to a central server. In some embodiments, the system may implement homomorphic encryption techniques that enable computation on encrypted data without requiring decryption. Access to the video data and output metrics may be controlled through role-based access control (RBAC) mechanisms that define different permission levels for subjects, coaches, analysts, and administrators.

A programmatic interface established and maintained by model-querying system 630, such as application programming interface (API) 634, may receive the source data tables 604 (which may include elements of the athlete data, athletic performance data, and data related to client device 205 or server device 225) from source systems 602, and API 634 may route source data tables 604 to a data ingestion and pre-processing engine 636 executed by the one or more processors of model-querying system 630. Executed ingestion and pre-processing engine 636 may also perform operations that store source data tables 604 (including the elements of athlete data, athletic performance data, and data related to client device 205 or server device 225) within a portion of the one or more tangible, non-transitory memories of model-querying system 630, e.g., as ingested source data vectors 633 of aggregated data store 635.

In some instances, executed ingestion and pre-processing engine 636 perform any of the exemplary data pre-processing operations described herein to selectively aggregate, filter, process, and/or transform subsets of source data tables 604, and to generate vectorized data records 638A that characterize corresponding ones of the athletes; vectorized data records 638B that characterize corresponding ones of the athletic performances; vectorized data records 638C that characterize corresponding ones of model or data relating to the ball tracking and trajectory estimation; vectorized data records 638D that characterize corresponding ones of model or data relating to post-processed ball trajectory; or vectorized data records 638E that characterize corresponding ones of model or data relating to flight characteristics of a projectile, within a corresponding grouping associated with the ingestion of source data tables 604 from one or more of source systems 602. Executed ingestion and pre-processing engine 636 may perform operations that store each of vectorized data records 638A-E within the one or more tangible, non-transitory memories of model-querying system 630, such as within consolidated data store 632. Consolidated data store 632 may, for instance, correspond to a data lake, a data warehouse, or another centralized repository established and maintained, respectively, by the distributed components of model-querying system 630, e.g., through a distributed file system (DFS).

In some instances, model-querying system 630 may perform operations that train adaptively a machine-learning or artificial-intelligence process, such as a machine learning module to: create a training scenario; generate a generated response based at least in part on an input prompt; and prepare a generated evaluation of an input response, using training datasets associated with a first grouping (e.g., a “training” grouping), and using validation datasets associated with a second, and distinct, grouping (e.g., an “validation” grouping). A predictive output of the trained, machine-learning or artificial-intelligence processes may, in some examples, produce pitch metrics. The disclosed embodiments are, however, not limited to these exemplary analyses and suggestions, and in other instances, model-querying system 630 may perform operations that train adaptively a machine-learning or artificial-intelligence process to predict a likelihood of an occurrence of any additional, or alternate, event appropriate to the consolidated elements of athlete data, athletic performance data, estimated ball tracking and trajectory data, post-processed ball trajectory data, or flight characteristics of a projectile data, maintained within consolidated data records 638, and appropriate to the machine-learning or artificial-intelligence processes.

Further, and as described herein, the machine-learning or artificial-intelligence processes may include a deep learning or neural network process, such as a Generative Pre-trained Transformer (GPT), and the training and validation datasets may include, but are not limited to, values of adaptively selected features obtained, extracted, or derived from the consolidated data records maintained within consolidated data store 632, e.g., from data elements maintained within the discrete data records of consolidated data records 638, as well as large language models, partially or completely encompassed within the follow-up question database. By way of example, the values of adaptively selected features of the training and validation datasets may be obtained, extracted, or derived from the consolidated, of athlete data, athletic performance data, estimated ball tracking and trajectory data, post-processed ball trajectory data, or flight characteristics of a projectile data that characterize the athelete, athletic performance, and model performance within respective ones of the training and validation groups, e.g., as maintained within the consolidated data records of consolidated data store 632. In some instances, and through a performance of one or more of the adaptive process training and validation operations described herein, model-querying system 630 may generate elements of process parameter data, which includes value of one or more process parameters for the trained, machine-learning or artificial-intelligence process, and elements of composition data, which identify each of feature of an input dataset for the trained, machine-learning or artificial-intelligence processes and specify a sequential position of each feature within the input dataset.

Further, and through the performance of one or more of the adaptive process training and validation operations described herein, model-querying system 630 may generate elements of explainability data that, among other things, characterize a relationship between a value of each, or a subset of, the features within the input dataset and the predictive output of the trained, machine-learning or artificial-intelligence processes. In some instances, the elements of explainability data may include a Shapley value associated with each of the features of the input dataset, and as described herein, the Shapley values may characterize a relative importance of each of the discrete features within the input dataset (e.g., as specified within the composition data), and further, a relationship between a magnitude of corresponding ones of the feature values and a magnitude of the predictive output.

By way of example, and for a particular input feature, a Shapley value of large magnitude may imply that a value of the particular input feature is associated with a corresponding, large contribution to the predicted output, and an increase in a magnitude of that particular feature value may drive an increase a magnitude of that predicted output. Further, for a particular input feature, a Shapley value of small magnitude may imply that a value of the particular input feature is associated with a corresponding, small contribution to the predicted output and to any increase in the magnitude of that predicted output. In some instances, the elements of explainability data generated through the adaptive training of the machine-learning or artificial intelligence processes may represent elements of reference explainability data that characterize, among other things, a baseline relationship between the values of the features within the input dataset and the predictive output of the machine-learning or artificial intelligence, and further, the reference explainability data may facilitate an application of one or more of the exemplary, dynamic explainability monitoring processes within one or more groups subsequent to the adaptive training of the machine-learning or artificial intelligence process, e.g., during a deployment of the trained machine-learning or artificial intelligence process.

Alternatively, and as disclosed above, rather than training additional or specific GPTs or large-language models (LLMs) directed to the functionality of a specific machine learning model, a more general LLM 652 may be utilized with prompts, queries, and enhanced context.

A modeling engine 646 executed by the one or more processors of model-querying system 630 may access the consolidated data records maintained within consolidated data store 632, such as, but not limited to, the discrete data records of consolidated data records 638. As described herein, each of the consolidated data records, such as discrete vectorized data records 638A-E of consolidated data records 638, may include consolidated data tables of athlete data, athletic performance data, estimated ball tracking and trajectory data, post-processed ball trajectory data, or flight characteristics of a projectile data (e.g., consolidated data tables 644).

In some examples, and as disclosed above, a query input module may prepare a query to be sent to an existing, trained, large language model 652. The query may contain a prompt, which may be particular to queries for a specific machine learning module. The prompt provides the query context, such that the LLM 652 is able to prepare a response in an expected scope and format.

The query also includes one or more vectorized data records 638A-E as input to the query. Generally, the query input is the element against which the query should return results. For example, in a machine learning module, the inputs are an input prompt, as any generated response should be related and matched to the client profile described in the input prompt; a training scenario prompt, as any training scenario should be related and matched to a client profile generated based upon the input data; and an input response, as any generated evaluation should be related and matched to a trainee input provided for evaluation.

The query further includes one or more vectorized data records 638A-E as enhanced context to the query. The enhanced context provides additional information to the query, in order to improve the accuracy of the produced response. For example, in a machine learning module, an enhanced context is an input augmenting prompt, as that prompt will provide context to the machine learning module regarding what task the machine learning module is to accomplish; the supplemental inputs are also enhanced context, as those inputs add additional exemplar scenarios and variety to improve the variability of training scenarios generated by the machine learning module, while still maintaining relevance and coherence of those training scenarios; the evaluation prompt is further enhanced context, as that prompt will provide context to the machine learning module regarding how the machine learning module is to evaluate the input response.

In some examples, a query input module 648 of executed training engine 646 may perform operations that access consolidated data records 638 maintained within consolidated data store 632. Executed training input module 648 may perform operations, described herein, that parse consolidated data records 638 and determine: (i) a first subset of consolidated data records 638A-E that are associated with an input grouping and may be appropriate to pass as input in a query to the LLM 652 for a particular machine-learning or artificial-intelligence process; and a (ii) second subset of consolidated data records 638A-E that are associated with an enhanced context grouping and may be appropriate to adding to a query as enhanced contextual information to the LLM for the particular machine-learning or artificial-intelligence process.

For instance, executed query input module 648 may access consolidated data records 638 maintained within consolidated data store 632, and parse each of the consolidated data records to obtain a corresponding athlete identifier (e.g., which associates with the consolidated data record with a corresponding one of the athletes tracked by the sporting club). For example, and based on the obtained trainee identifier, executed training input module 648 may obtain trainee-specific groups of consolidated data records 638 associated with corresponding ones of the trainee identifiers (e.g., trainee-specific sets of discrete data records). Through these exemplary processes, executed training input module 648 may generate trainee-specific groups of data records, including corresponding, trainee-specific consolidated data tables, which executed training input module 648 may maintain locally within the consolidated data store 632 (not illustrated in FIG. 6).

The same process above can be used to obtain scenario identifiers and generate scenario-specific groups of data records, as well as to obtain evaluation identifiers, and generate evaluation-specific groups of data records, either of which executed training input module 648 may maintain locally within the consolidated data store 632.

Executed query input module 648 may also perform operations that partition the client, instrument, and performance record groups of data records into the subsets suitable for querying the machine-learning or artificial-intelligence process and for validating the machine-learning or artificial-intelligence processes.

Executed query input module 648 may perform operations that generate one or more query inputs based on elements of obtained, extracted, or derived from all or a selected portion of the first subset of the consolidated data records 638 (e.g., that are suitable as query inputs for the machine-learning or artificial-intelligence processes), and additionally, or alternatively, based on elements of ingested of athlete data or athletic performance data maintained within the one or more tangible, non-transitory memories of model-querying system 630 (e.g., portions of ingested source data tables 633 of aggregated data store 635).

Executed query input module 648 may perform operations that generate one or more query enhanced contexts based on elements of obtained, extracted, or derived from all or a selected portion of the second subset of the consolidated data records 638 (e.g., that are suitable as query enhanced contexts for the machine-learning or artificial-intelligence processes), and additionally, or alternatively, based on elements of ingested athlete data or athletic performance data maintained within the one or more tangible, non-transitory memories of model-querying system 630 (e.g., portions of ingested source data tables 633 of aggregated data store 635).

In some instances, described herein, the query containing the query input and query enhanced context (along with any query prompt) may, when provisioned to an input layer of the GPT process or LLM 652, enable executed LLM 652 processes to determine and describe a correlation between a particular prompt and a particular response between a particular response and a particular evaluation.

As described herein, the large language model 652 may be a general purpose large language model, or may be a particularized large language model, trained in part or completely on vectorized data records 638A-E from the consolidated data store 632 associated with a corresponding one of the subscribers, financial instruments, or performance records, as well as other data from source system 602 associated with, among other things, a corresponding subscriber, instrument, or performance record. Each of the vectorized data records 638A-E may also include elements of data (e.g., feature values) that characterize the corresponding one of the clients, instruments, and risks.

In some instances, a vectorized data record 638A-E may include a value of one or more numerical input features, and additionally or alternatively, a value of one or more categorical input features, and examples of the categorical input features. Further, and by way of example, executed query input module 648 may perform operations that identify, and obtain or extract, one or more of the features values from a corresponding one of vectorized data records 638A-E maintained within the first or second subset, and additionally, or alternatively, from elements of ingested source data tables 633, that include, or reference, the corresponding athlete or athletic performance record identifier and that characterize the corresponding athlete or athletic performance record, respectively. Executed query input module 648 may also perform operations that compute, determine, or derive one or more of the features values based on elements of data extracted or obtained from a corresponding one of consolidated data records maintained within the first subset, and additionally, or alternatively, from elements of ingested source data vectors 633, that include, or reference, the corresponding client, instrument, or performance record identifier.

In some examples, after the large language model 652 produces a query response ingested by the query response module 656, an explainability module 662 of executed query response module 656 may perform operations that characterize a relative of importance of discrete features within one or more of training datasets 652 through a generation of corresponding Shapley values and/or through a generation of values of probabilistic metrics that average a computed area under curve for receiver operating characteristic (ROC) curves.

In some instances, the distributed components of model-querying system 630 may execute query input module 648 and may perform any of the exemplary processes described herein in parallel to query the large language model 652 with the inputs and enhancing context of the consolidated data store 632. The parallel implementation of query input module 648 by the distributed components of model-querying system 630 may, in some instances, be based on an implementation, across the distributed components, of one or more of the parallelized, fault-tolerant distributed computing and analytical protocols described herein (e.g., the Apache Spark™ distributed, cluster-computing framework).

Through the performance of these querying processes, executed query input module 648 may perform operations that iteratively add, subtract, or combine discrete features of vectorized data records 638A-E, and that generate one or more intermediate vectorized data records reflecting the iterative addition, subtraction, or combination of discrete features from corresponding ones of vectorized data records 638A-E, and in some instances, an intermediate set of process parameters for the LLM-querying process (e.g., to correct errors, etc.).

In some examples, executed query response module 656 may perform operations that determine whether all, or a selected portion of, the query response satisfies one or more threshold conditions for a forwarding of the response to a training device or an administrator device display. For instance, the one or more threshold conditions may specify one or more predetermined threshold values for the query response, such as, but not limited to, a predetermined threshold value based on the vectorized data records 638A-E used as enhanced context. In some examples, an executed query response module that establishes whether one, or more, of the computed values exceed, or fall below, a corresponding one of the predetermined threshold values and as such, whether the query response from the large language model is sufficiently accurate for forwarding.

If, for example, executed query response module 656 were to establish that one, or more, of the computed metric values fail to satisfy at least one of the threshold requirements, model-querying system 630 may establish that the query response is insufficiently accurate for determining flight characteristics, pitch trajectory, or pitch metrics. Executed query response module 656 may perform operations (not illustrated in FIG. 6) that transmit data indicative of the established inaccuracy to executed query input module 648, which may perform any of the exemplary processes described herein to generate one or more additional queries, which may be provisioned as a revised query to the large language model 652. In some instances, executed adaptive query response module 656 may receive the additional queries, and may perform any of the exemplary processes described herein to train further the large language model 652 against the additional queries or the consolidated data store 632.

In some instances, and based on query response associated with corresponding vectorized data records 638A-E, an explainability module 662 of executed query response module 656 may perform any of the exemplary processes described herein, in conjunction with executed query response module 656 to generate one or more elements of reference explainability data, that characterize, among other things, a presence or absence in the query response of each of the input features specified within the query on an outcome of the large language model 652 and a contribution of each of the features to the query response from the large language model 652.

As described herein, the elements of reference explainability data may characterize, among other things, a baseline relationship between the values of the features within the query and the query response of the large language model 652. Further, the elements of reference explainability data may facilitate an application of one or more explainability monitoring processes during one or more temporal intervals subsequent to the querying of the large language model 652.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Exemplary embodiments of the subject matter described in this specification, such as, but not limited to, client device 205, server device 225, analyst device 265, and computing environment 200, can be implemented as one or more computer programs, i.e., one or more modules of computer program instructions encoded on a tangible non-transitory program carrier for execution by, or to control the operation of, a data processing apparatus (or a computer system). According to some embodiments, “function,” “functions,” “application,” “applications,” “instruction,” “instructions,” or “programming” are program(s) that execute functions defined in the programs. Various programming languages can be employed to create one or more of the applications, structured in a variety of manners, such as object-oriented programming languages (e.g., Objective-C, Java, or C++), procedural programming languages (e.g., C or assembly language), or firmware. In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate functionality described herein.

Additionally, or alternatively, the program instructions can be encoded on an artificially generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The terms “apparatus,” “device,” and “system” refer to data processing hardware and encompass all kinds of apparatus, devices, and machines for processing data, including, by way of example, a programmable processor such as a graphical processing unit (GPU) or central processing unit (CPU), a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array), an ASIC (application-specific integrated circuit), one or more processors, or any other suitable logic.

Computers suitable for the execution of a computer program include, by way of example, general or special purpose microprocessors or both, or any other kind of central processing unit. Generally, a CPU will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display unit, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, other embodiments will be apparent to those skilled in the art from consideration of the specification and practice of one or more embodiments of the present disclosure. It is intended, therefore, that this disclosure and the examples herein be considered as exemplary only, with a true scope and spirit of the disclosed embodiments being indicated by the following listing of exemplary claims.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims. It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element unless the context clearly and unambiguously dictates otherwise.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus the following claims are hereby incorporated into the Detailed Description, with each claim standing on its own as a separately claimed subject matter.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

Additional embodiments and features are described below, which may be claimed in this or one or more related applications:

A system comprising:
a processor;
a memory, coupled to the processor; and
programming in the memory, wherein execution of the programming by the processor configures the system to:
   capture a video;
   assign an estimated propulsion stage to one or more frames;
   determine a propulsion initiation frame;
   identify a frame buffer;
   produce a propulsion video segment;
   transmit the propulsion video segment over a network;
   detect a propulsor;
   detect a projectile;
   determine one or more initial projectile coordinates;
   identify one or more movement frames;
   determine one or more intermediate projectile motion coordinates; and
   calculate initial velocity vector.

The system above, wherein execution of the programming by the processor further configures the system to:
tag key locations;
identify a pre-initiation frame buffer;
identify a post-initiation frame buffer;
stabilize the propulsion video segment;
crop the propulsion video segment based on key locations;
determine sub-frame based on propulsor coordinates;
reduce video distortion in sub-frame;
identify a post-launch initiation frame buffer;
determine a projectile cessation;
smooth the one or more projectile motion coordinates;
normalize the one or more projectile motion coordinates;
calculate expected cessation velocity vector;
calculate actual cessation velocity vector;
calculate a Magnus force vector; and
transmit one or more velocity vectors, the Magnus force vector, or a combination thereof, over the network.

What is claimed is:

1. A method for analyzing projectile motion, the method comprising:
receiving image data comprising at least two frames, the at least two frames capturing a projectile;
determining a spatial relationship between a capture device and an environment;
detecting, using a first machine learning model, the projectile within the at least two frames to generate projectile coordinates;
processing the projectile coordinates to generate a projectile trajectory;
estimating, using a second machine learning model, flight characteristics of the projectile based on the projectile trajectory and parameters derived from the spatial relationship;
refining the estimated flight characteristics; and
calculating one or more projectile metrics from the refined flight characteristics.

2. The method of claim 1, wherein receiving the image data comprises capturing, by a camera, video comprising the at least two frames.

3. The method of claim 2, wherein the video is captured at a frame rate of at least 240 frames per second.

4. The method of claim 1, wherein determining the spatial relationship comprises performing an extrinsic calibration to determine a position of the capture device in three-dimensional real-world coordinates relative to the environment.

5. The method of claim 4, wherein performing the extrinsic calibration comprises:
detecting one or more keypoints in the environment; and
performing a perspective-n-point calibration process using the detected keypoints.

6. The method of claim 1, further comprising detecting, using a video action recognition model, an occurrence of a projectile event within the image data, and responsive to detecting the occurrence of the projectile event, storing a plurality of frames corresponding to the projectile event.

7. The method of claim 6, wherein detecting the occurrence of the projectile event comprises:
creating windows of a predetermined number of frames from the image data;
feeding the windows to the video action recognition model to generate a probability output; and
triggering the projectile event when the probability output exceeds a threshold.

8. The method of claim 1, wherein the first machine learning model comprises an object tracking neural network.

9. The method of claim 1, wherein processing the projectile coordinates comprises applying a filter to the projectile coordinates to reduce noise.

10. The method of claim 9, wherein the filter comprises a Kalman filter, and wherein processing the projectile coordinates further comprises one or more of outlier rejection, gap infilling, and linear interpolation.

11. The method of claim 1, wherein the second machine learning model comprises a transformer-based neural network.

12. The method of claim 1, wherein the flight characteristics comprise an initial state vector including one or more of:
i) initial position components;
ii) initial velocity components;
iii) spin axis information;
iv) a spin efficiency factor; and
v) a spin rate.

13. The method of claim 1, wherein refining the estimated flight characteristics comprises applying a physics-driven optimization algorithm.

14. The method of claim 13, wherein the physics-driven optimization algorithm refines the flight characteristics based on one or more of pixel reprojection errors, physical flight kinematics, and time-of-flight constraints.

15. A system for analyzing projectile motion, the system comprising:
one or more processors; and
a memory storing instructions that, when executed by the one or more processors, cause the one or more processors to:
receive image data comprising at least two frames, the at least two frames capturing a projectile;
determine a spatial relationship between a capture device and an environment;
detect, using a first machine learning model, the projectile within the at least two frames to generate projectile coordinates;
process the projectile coordinates to generate a projectile trajectory;
estimate, using a second machine learning model, flight characteristics of the projectile based on the projectile trajectory and parameters derived from the spatial relationship;
refine the estimated flight characteristics; and
calculate one or more projectile metrics from the refined flight characteristics.

16. The system of claim 15, wherein:
the system comprises a client device and a server device in communication with the client device;
the client device is configured to capture the image data and detect the projectile; and
the server device is configured to estimate and refine the flight characteristics.

17. The system of claim 15, wherein the second machine learning model comprises a transformer encoder architecture trained using synthetic training data generated by simulating projectile trajectories using physics-based processes.

18. The system of claim 15, further comprising a camera;
wherein receiving the image data comprises capturing, by the camera, video comprising the at least two frames.

19. A non-transitory computer-readable medium storing instructions that, when executed by one or more processors, cause the one or more processors to perform operations comprising:
receiving image data comprising at least two frames, the at least two frames capturing a projectile;
determining a spatial relationship between a capture device and an environment;
detecting, using a first machine learning model, the projectile within the at least two frames to generate projectile coordinates;
processing the projectile coordinates to generate a projectile trajectory;
estimating, using a second machine learning model, flight characteristics of the projectile based on the projectile trajectory;
refining the estimated flight characteristics to generate refined flight characteristics;
computing a three-dimensional projectile trajectory based on the refined flight characteristics; and
calculating one or more projectile metrics from the three-dimensional projectile trajectory.

20. The non-transitory computer-readable medium of claim 19, wherein:
the flight characteristics comprise an initial state vector including initial position components, initial velocity components, and spin information; and
refining the estimated flight characteristics comprises applying an optimization algorithm based on one or more of pixel reprojection errors, physical flight kinematics, and time-of-flight constraints.
